(19) United States
(12) Patent Application Publication
(10) Pub. No.: US 2025/0391899 A1
(43) Pub. Date: Dec. 25, 2025

(54) SOLID-STATE SECONDARY BATTERY, METHOD FOR PREPARING THE SAME, ENERGY STORAGE SYSTEM AND ELECTRIC EQUIPMENT

(71) Applicant: Zhejiang Jinko Energy Storage Co., Ltd., Haining (CN)

(72) Inventors: Shoumin CHEN, Haining (CN); Guo LIU, Haining (CN); Zixiang YANG, Haining (CN); Luhua ZHANG, Haining (CN)

(21) Appl. No.: 19/313,843

(22) Filed: Aug. 28, 2025

(30) Foreign Application Priority Data
Jun. 17, 2025 (CN) 202510813543.3

(51) Int. Cl. H01M 10/04; H01M 4/02; H01M 4/04; H01M 4/1393; H01M 4/36; H01M 4/40; H01M 10/0562

(52) U.S. Cl. CPC H01M 10/04; H01M 4/0402; H01M 4/1393; H01M 4/364; H01M 4/405; H01M 10/0562; H01M 2004/027; H01M 2004/028

(57) ABSTRACT

Provided is a method for preparing a solid-state secondary battery, including: forming a solid-state electrolyte, including: preparing a ceramic aerosol including inorganic ceramic oxide particles and polyimide particles; providing a substrate layer and spraying the ceramic aerosol onto at least one side of the substrate layer; performing heat treatment on the substrate layer to remove the polyimide particles and convert the inorganic ceramic oxide particles into a plurality of branches, where gaps are formed between adjacent branches of the plurality of branches; applying a coating slurry onto one side of the substrate layer; performing drying treatment; preparing a positive electrode sheet and a negative electrode sheet; and encapsulating the battery casing to obtain the solid-state secondary battery.

### CROSS REFERENCE TO RELATED APPLICATIONS

The present application claims the benefit of priority under the Paris Convention to Chinese Patent Application No. 202510813543.3 filed on Jun. 17, 2025, which is incorporated herein by reference in its entirety.

### TECHNICAL FIELD

The various embodiments described in this document relate to the field of battery technology, and in particular, to a solid-state secondary battery, a method for preparing the same, an energy storage system, and an electric equipment.

### BACKGROUND

Lithium secondary batteries are currently the primary chemical power source for various applications such as power and energy storage, offering significant advantages in specific energy, service life, cost-effectiveness and the like. However, the conflict between specific energy and safety, along with lithium resource constraints, has spurred the development of novel secondary batteries. Among these, solid-state lithium batteries and sodium batteries have emerged as the strongest competitors to lithium-ion batteries.

A solid-state electrolyte can fundamentally enhance the safety of the secondary battery and effectively improve energy density. Electrode materials must satisfy multi-dimensional compatibility requirements with electrolyte materials in chemical, mechanical, thermal, and electrochemical processes. Performance enhancement and optimization can be achieved through modifications to electrode active materials, electrolytes, and interfaces. Nevertheless, current solid-state secondary batteries face challenges during application, such as poor solid-solid interfacial contact between the electrolyte and the active material, which adversely affects characteristics such as internal resistance.

### SUMMARY

Embodiments of the present disclosure provide a solid-state secondary battery, a method for preparing the same, an energy storage system, and an electric equipment, which at least mitigate the issue of poor solid-solid interfacial contact between the electrolyte and the active material in the solid-state secondary battery.

According to some embodiments, one aspect of the present disclosure provides a method for preparing a solid-state secondary battery. The method includes: forming a solid-state electrolyte, including: preparing a ceramic aerosol, where the ceramic aerosol includes inorganic ceramic oxide particles and polyimide particles; providing a substrate layer and spraying the ceramic aerosol onto at least one side of the substrate layer; performing heat treatment on the substrate layer to remove the polyimide particles and convert the inorganic ceramic oxide particles into a plurality of branches on the at least one side of the substrate layer, where gaps are formed between adjacent branches of the plurality of branches, and the plurality of branches are located; preparing a coating slurry; applying the coating slurry onto a side of the substrate layer, the coating slurry flowing into the gaps; performing drying treatment to convert the coating slurry into an active layer to obtain the solid-state electrolyte including the substrate layer and the plurality of branches; preparing a positive electrode sheet and a negative electrode sheet, including: providing a current collector, where the active layer is located between the current collector and the substrate layer; and stacking the negative electrode sheet, the solid-state electrolyte, and the positive electrode sheet in sequence, followed by hot pressing to obtain a bare cell, placing the bare cell into a battery casing, and encapsulating the battery casing to obtain the solid-state secondary battery.

In some embodiments, the plurality of branches contain pores, and the coating slurry further flows into the pores.

In some embodiments, before performing the drying treatment, the method further includes: performing ultrasonic treatment to allow the coating slurry to fill the pores, where the ultrasonic treatment has an ultrasonic treatment time of 3 min to 15 min, and an ultrasonic frequency of 20 kHz to 5 MHz.

In some embodiments, the coating slurry includes a dispersion solution containing a wetting agent configured to facilitate the flow of the coating slurry into the pores.

In some embodiments, in the operation of preparing the ceramic aerosol, a volume ratio of the inorganic ceramic oxide particles to the polyimide particles is 1:(1 to 10).

In some embodiments, process parameters for the heat treatment include: a reaction temperature of 500° C. to 1000° C.; a calcination time of 0.8 h to 1.2 h; and a sweeping gas flow rate of 0.5 L/min to 3 L/min.

In some embodiments, the inorganic ceramic oxide particles include Li_{0.33}La_{0.56}TiO₃ (LLTO), Li₇La₃Zr₂O₁₂ (LLZTO), or C₂F₆LiNO₄S₂ (LiTFSI).

In some embodiments, preparing the ceramic aerosol includes: feeding, by a gas delivery device, a mixture of the inorganic ceramic oxide particles and the polyimide particles into an aerosol chamber with a carrier gas to enable uniform dispersion of the mixture so as to form the ceramic aerosol, wherein the carrier gas is helium or oxygen

In some embodiments, the coating slurry includes an active material coated with Ga-LLZO, and forming the active material includes: uniformly mixing Ga-LLZO particles, active particles, and a solution to form a first mixed solution; drying the first mixed solution to form a first precursor; and calcining the first precursor to form the active material. A mass ratio of the Ga-LLZO particles to the active particles is (0.5 wt % to 2 wt %):(8 wt % to 9.5 wt %).

In some embodiments, preparing the coating slurry includes: uniformly mixing an active material, nano inorganic ceramic oxide particles, a conductive agent, a binder, and a dispersion solution to obtain a second mixed solution; and subjecting the second mixed solution to high-speed dispersion under a negative pressure for 4 h to 6 h to obtain the coating slurry, where the coating slurry has a viscosity of 5000 mPa·s to 20000 mPa·s. A mass ratio of the active material, the nano inorganic ceramic oxide particles, the conductive agent, and the binder is (73 wt % to 93 wt %):(5 wt % to 18 wt %):(0.6 wt % to 4.5 wt %):(1.4 wt % to 4.5 wt %).

In some embodiments, the second mixed solution has an average particle size of less than 20 μm.

In some embodiments, in response to the active material being a positive electrode active material, the current collector is a positive electrode current collector; and in response to the active material being a negative electrode active material, the current collector is a negative electrode current collector.

In some embodiments, the positive electrode active material is a lithium source material, and the negative electrode active material is graphite.

In some embodiments, the coating slurry includes an active material which is graphite, and after forming the solid-state electrolyte, the method further includes: uniformly mixing lithium bis(fluorosulfonyl)imide, poly(ethylene glycol)methyl ether methacrylate, poly(ethylene glycol)dimethacrylate, a photoinitiator, graphite, and conductive carbon black to obtain a curing solution; and immersing the solid-state electrolyte into the curing solution and performing curing treatment on the solid-state electrolyte with the curing solution. A mass ratio of lithium bis(fluorosulfonyl)imide, poly(ethylene glycol)methyl ether methacrylate, poly(ethylene glycol)dimethacrylate, the photoinitiator, the graphite and the conductive carbon black is (35 wt % to 55 wt %): (30 wt % to 50 wt %): (1 wt % to 7.5 wt %): (1.5 wt % to 4.5 wt %): (2 wt % to 7 wt %): (1 wt % to 3 wt %).

In some embodiments, the current collector is a positive electrode current collector, and preparing the positive electrode sheet includes: providing the positive electrode current collector on a surface of the active layer; and performing hot pressing treatment on the solid-state electrolyte and the positive electrode current collector, where the active layer and the positive electrode current collector constitute the positive electrode sheet.

In some embodiments, the positive electrode sheet further includes a positive sub-active layer, and before providing the positive electrode current collector over the surface of the active layer, preparing the positive electrode sheet further includes: preparing the positive sub-active layer over the surface of the active layer, where the positive sub-active layer is between the active layer and the positive electrode current collector. The active layer, the positive sub-active layer, and the positive electrode current collector constitute the positive electrode sheet.

In some embodiments, the current collector is a negative electrode current collector, and preparing the negative electrode sheet includes: providing the negative electrode current collector over a surface of the active layer; and performing hot pressing treatment on the solid-state electrolyte and the negative electrode current collector, where the active layer and the negative electrode current collector constitute the positive electrode sheet.

In some embodiments, the negative electrode sheet further includes a negative sub-active layer, and before providing the negative electrode current collector over the surface of the active layer, preparing the negative electrode sheet further includes: preparing the negative sub-active layer over the surface of the active layer, where the negative sub-active layer is between the active layer and the negative electrode current collector. The active layer, the negative sub-active layer, and the negative electrode current collector constitute the negative electrode sheet.

### BRIEF DESCRIPTION OF THE DRAWINGS

One or more embodiments are described by way of example with reference to the corresponding figures in the accompanying drawings, and the exemplary description is not to be construed as limiting the embodiments. Unless otherwise particularly stated, the figures in the accompanying drawings are not drawn to scale. To describe the technical solutions of the embodiments of the present disclosure or the related art more clearly, the accompanying drawings that need to be used in the embodiments are briefly described below. Apparently, the accompanying drawings in the following description show only some embodiments of the present disclosure, and a person of ordinary skill in the art may still derive other drawings from these accompanying drawings without creative efforts.

FIG. 1 is a flow chart corresponding to a method for preparing a solid-state secondary battery according to embodiments of the present disclosure.

FIG. 2 is a first schematic structure diagram of a solid-state secondary battery according to embodiments of the present disclosure.

FIG. 3 is a top view of a solid-state electrolyte in a solid-state secondary battery according to embodiments of the present disclosure.

FIG. 4 is a second schematic structure diagram of a solid-state secondary battery according to embodiments of the present disclosure.

FIG. 5 is a third schematic structure diagram of a solid-state secondary battery according to embodiments of the present disclosure.

FIG. 6 is a fourth schematic structure diagram of a solid-state secondary battery according to embodiments of the present disclosure.

FIG. 7 is a fifth schematic structure diagram of a solid-state secondary battery according to embodiments of the present disclosure.

FIG. 8 is a sixth schematic structure diagram of a solid-state secondary battery according to embodiments of the present disclosure.

FIG. 9 is a seventh schematic structure diagram of a solid-state secondary battery according to embodiments of the present disclosure.

FIG. 10 is an eighth schematic structure diagram of a solid-state secondary battery according to embodiments of the present disclosure.

FIG. 11 is a ninth schematic structure diagram of a solid-state secondary battery according to embodiments of the present disclosure.

FIG. 12 is a tenth schematic structure diagram of a solid-state secondary battery according to embodiments of the present disclosure.

FIG. 13 is an eleventh schematic structure diagram of a solid-state secondary battery according to embodiments of the present disclosure.

Reference Numerals:

| | | | |
|---|---|---|---|
| 1 | Positive electrode sheet; | 2 | Negative electrode sheet; |
| 110 | Branch; | 100 | Substrate layer; |
| 101 | Active layer; | 102 | Secondary sphere |
| | | | aggregate; |
| 103 | Ga-LLZO coated active | 104 | PEG-based polymer |
| | material; | | network; |
| 105 | Graphite/carbon black | | |
| | conductive pathway; | | |
| 210 | Arrayed pillar; | 200 | Substrate layer; |
| 201 | Active layer; | 202 | Secondary sphere |
| | | | aggregate; |
| 203 | Ga-LLZO coated active | 204 | PEG-based polymer |
| | material; | | network; |
| 205 | Graphite/carbon black | | |
| | conductive pathway; | | |
| 300 | Substrate layer; | 301 | Active layer; |
| 302 | Secondary sphere | 303 | Ga-LLZO coated active |
| | aggregate; | | material; |
| 304 | PEG-based polymer | 305 | Graphite/carbon black |
| | network; | | conductive pathway. |

### DETAILED DESCRIPTION OF THE EMBODIMENTS

As known from the background part, current solid-state secondary batteries suffer from poor solid-solid interfacial contact between the electrolyte and the active material, adversely affecting characteristics such as internal resistance.

In the solid-state secondary battery according to embodiments of the present application, the solid-state electrolyte is prepared so that branches are formed on the surface of the solid-state electrolyte and are positioned between the positive electrode sheet and the substrate layer and/or between the negative electrode sheet and the substrate layer, enabling the positive active layer of the positive electrode sheet to interlock and be mutually embed with the solid-state electrolyte, and the negative active layer of the negative electrode sheet to interlock and be mutually embed with the solid-state electrolyte, thereby increasing contact area and reducing battery internal resistance. Furthermore, the aerosol process is adopted to form branches on the surface of the substrate layer, and subsequent formation of the active layer in gaps between the branches allows the active layer to serve dual functions: as a positive/negative active layer and as a contact enhancement layer to improve contact performance. During subsequent rolling pressing operations, this ensures tight interfacial contact between the solid-state electrolyte layer and the positive/negative electrode sheets.

In the description of the embodiments of the present disclosure, the technical terms “first” “second” and the like are only used to distinguish different objects and cannot be understood as indicating or implying relative importance or implicitly indicating the number, specific order, or primary and secondary relationship of the indicated technical features. In the description of the embodiments of the present disclosure, “a plurality of” means at least two, unless otherwise specified.

Reference herein to “embodiment” means that a particular feature, structure, or characteristic described in connection with the embodiment may be included in at least one embodiment of the present disclosure. The appearances of this phrase in various places in the specification are not necessarily all referring to the same embodiment, nor are separate or alternative embodiments that are mutually exclusive with other embodiments. It is explicitly and implicitly understood by those skilled in the art that the embodiments described herein may be combined with other embodiments.

In the description of the embodiments of the present disclosure, the term “and/or” is merely an association relationship describing associated objects, indicating that there may be three relationships, for example, A and/or B, which may indicate that A exists, A and B exist at the same time, and B exists. In addition, the character “/” in this specification generally indicates an “or” relationship between the associated objects.

In the description of the embodiments of the present disclosure, the term “a plurality of” means at least two, similarly, “a plurality of groups” means at least two groups, and “a plurality of pieces” means at least two pieces.

In the description of the embodiments of the present disclosure, orientation or positional relationship indicated by technical terms “center”, “transverse”, “longitudinal”, “length”, “width”, “thickness”, “up”, “down”, “front”, “rear”, “left”, “right”, “vertical”, “horizontal”, “top”, “bottom”, “inside” “outside”, “clockwise”, “counterclockwise”, “axial”, “radial”, “circumferential” and the like are orientations or positional relationships based on those shown in the accompanying drawings, which are intended only to facilitate the description of embodiments of the present disclosure and to simplify the description, and are not intended to indicate or imply that the device or element referred to must have a particular orientation, be constructed and operated with a particular orientation, and therefore are not to be construed as a limitation of the embodiments of the present disclosure.

In the description of the embodiments of the present disclosure, unless otherwise specified and limited, technical terms “mounted”, “connected”, “connecting”, “fixed”, etc. are to be understood in a broad sense. For example, it may be a fixed connection, a removable connection, or a one-piece connection, it may be a mechanical connection, or an electrical connection, it may be a direct connection, or an indirect connection through an intermediate medium, and it may be a connection between two elements or an interaction between the two elements. For those of ordinary skill in the art, specific meanings of the above terms in the embodiments of the present disclosure may be understood according to specific situations.

In the accompanying drawings corresponding to the embodiments of the present disclosure, for better understanding and ease of description, the thickness and area of a layer are enlarged. When a component (e.g., a layer, a film, a region, or a substrate) is described as being formed over another component or over a surface of another component, the component may be “directly” on the surface of another component, or a third component may exist between the two components. In contrast, when a component is described as being formed on a surface of another component or a surface of a component is formed or provided with another component, there is no third component between the two components. In addition, when a component is described as being “substantially” formed on/over another component, it means that the component is not formed on/over the entire surface (or front surface) of another component, nor on/over a portion of the edge of the entire surface.

In the description of the embodiments of the present disclosure, when a component “includes” another component, unless otherwise stated, other components are not excluded, and other components may be further included in the component. In addition, when a component such as a layer, a film, a region, or a plate is referred to as being “over/disposed over” another component, it may be “directly on” another component (i.e., being on the surface of another component and there is no other component therebetween), or another component may exist therebetween. Furthermore, when a component such as a layer, film, region, plate, etc. is “directly on” another component, or when a component such as a layer, film, region, plate, etc. is disposed on the surface of another component, it means that no other component is disposed therebetween.

The terminology used in the description of the various described embodiments herein is for the purpose of describing particular embodiments only and is not intended to be limiting. As used in the description of the various embodiments described and the appended claims, “the portion” is also intended to include the plural forms as well, unless the context clearly indicates otherwise. The component includes a layer, a film, a region, or a plate, etc.

The following describes the embodiments of the present disclosure in detail with reference to the accompanying drawings. However, a person of ordinary skill in the art may understand that in the embodiments of the present disclosure, many technical details are provided to make readers better understand the embodiments of the present disclosure. However, even without these technical details and various changes and modifications based on the following embodiments, the technical solutions claimed in the embodiments of the present disclosure can be implemented.

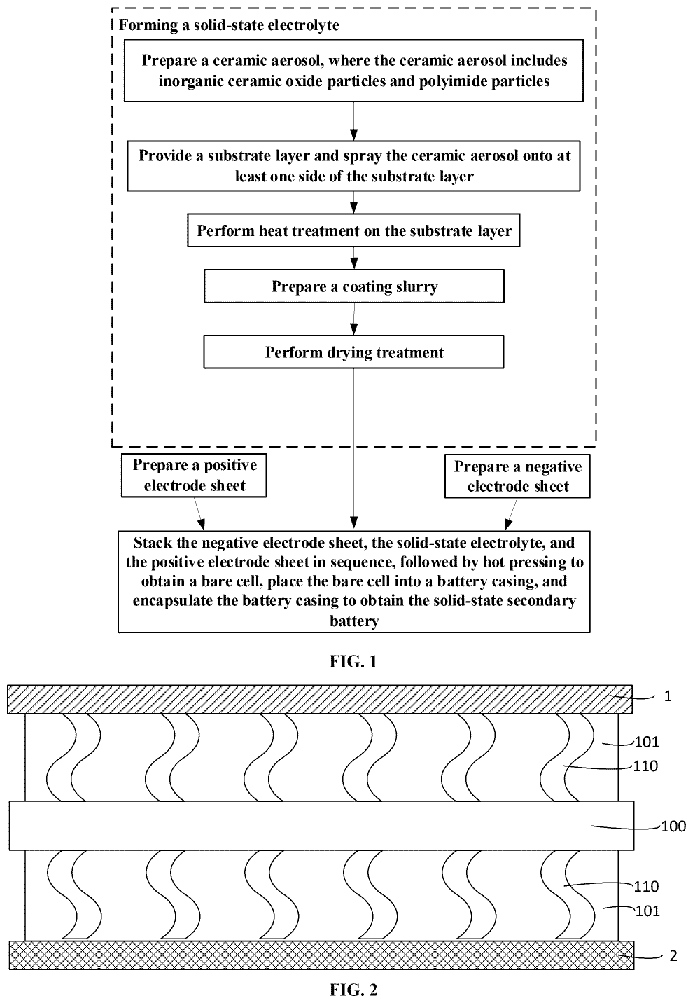

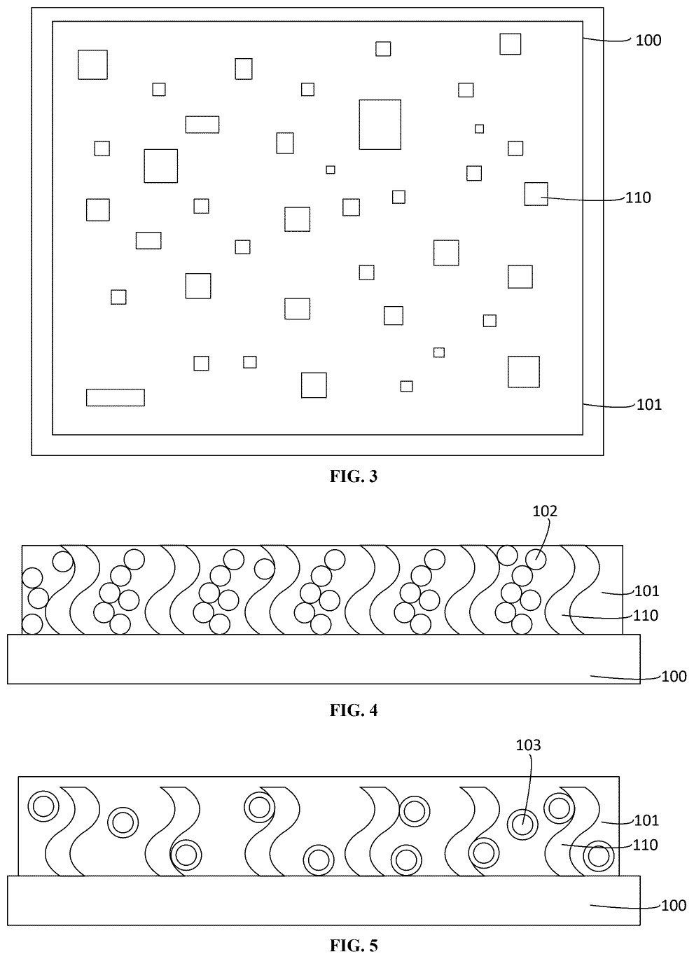

FIG. 1 is a flow chart corresponding to a method for preparing a solid-state secondary battery according to embodiments of the present disclosure. FIG. 2 is a first schematic structure diagram of a solid-state secondary battery according to embodiments of the present disclosure. FIG. 3 is a top view of a solid-state electrolyte in a solid-state secondary battery according to embodiments of the present disclosure.

It should be noted that FIG. 2 is viewed from a top cover toward the casing, showing side views of the positive electrode sheet, negative electrode sheet, and solid-state electrolyte to clearly illustrate their interrelation. FIG. 2 illustrates the active layer including a positive active layer and a negative active layer. Those skilled in the art may configure branches and an active layer on only one side of the substrate layer as needed. The active layer in FIG. 3 is shown in perspective to visualize the arrangement between branches and the substrate layer.

Referring to FIGS. 1 to 3, the method includes: forming a solid-state electrolyte, including: preparing a ceramic aerosol, where the ceramic aerosol includes inorganic ceramic oxide particles and polyimide particles; providing a substrate layer 100 and spraying the ceramic aerosol onto at least one side of the substrate layer 100; performing heat treatment on the substrate layer 100 to remove the polyimide particles and convert the remaining inorganic ceramic oxide particles into a plurality of branches 110 on the at least one side of the substrate layer 100, where gaps are formed between adjacent branches 110 of the plurality of branches 110; preparing a coating slurry; applying the coating slurry onto a side of the substrate layer 100, the coating slurry flowing into the gaps; performing drying treatment to convert the coating slurry into an active layer 101 to obtain the solid-state electrolyte including the substrate layer 100 and the plurality of branches 110; preparing a positive electrode sheet 1 and a negative electrode sheet 2, including: providing a current collector, where the active layer 101 is located between the current collector and the substrate layer 100; and stacking the negative electrode sheet 2, the solid-state electrolyte, and the positive electrode sheet 1 in sequence, followed by hot pressing to obtain a bare cell, placing the bare cell into a battery casing, and encapsulating the battery casing to obtain the solid-state secondary battery.

In the solid-state secondary battery according to embodiments of the present application, the solid-state electrolyte is prepared so that branches 110 are formed on the surface of the solid-state electrolyte and are positioned between the positive electrode sheet and the substrate layer 100 and/or between the negative electrode sheet and the substrate layer 100, enabling the positive active layer of the positive electrode sheet 1 to interlock and be mutually embed with the solid-state electrolyte, and the negative active layer of the negative electrode sheet 2 to interlock and be mutually embed with the solid-state electrolyte, thereby increasing contact area and reducing battery internal resistance. Furthermore, the aerosol process is adopted to form branches 110 on the surface of the substrate layer 100, and subsequent formation of the active layer 101 in gaps between the branches 110 allows the active layer 101 to serve dual functions: as a positive/negative active layer and as a contact enhancement layer to improve contact performance. During subsequent rolling pressing operations, this ensures tight interfacial contact between the solid-state electrolyte layer and the positive/negative electrode sheets.

The preparation method provided above is described in detail below.

According to shape classification, the prepared solid-state secondary batteries may be classified into prismatic cells, cylindrical cells, or pouch cells. By capacity classification, secondary batteries may be categorized into models such as 50 Ah, 100 Ah, 150 Ah, 200 Ah, 280 Ah, 306 Ah, 314 Ah, 500+ Ah, 800+ Ah, and 1000+ Ah. According to chemical composition and working principle of the bare cell, secondary batteries may include lithium-ion batteries, lead-acid batteries, sodium-ion batteries, or nickel-metal hydride batteries. The embodiments of the present disclosure use the method for preparing lithium-ion batteries as an example. Those skilled in the art can replace lithium ions in the positive electrode sheet, negative electrode sheet, and electrolyte with corresponding metal ions according to actual needs. For example, for sodium-ion batteries, the lithium transition metal oxide in the positive active material may be replaced with corresponding layered metal oxides (e.g., NaFeO₂), polyanionic compounds (NaFePO₄), or Prussian blue analogs (e.g., NaMnFe(CN)₆−zH₂O).

A solid-state electrolyte (SSE) is a solid ionic conductor and an electronic insulator, serving as a key component of a solid-state secondary battery. Compared with a liquid electrolyte, the solid-state electrolyte offers advantages including safety, absence of toxic organic solvent leakage, non-flammability, non-volatility, mechanical and thermal stability, case of processing, low self-discharge, and potential for higher power density and cyclability. For instance, a solid-state electrolyte membrane can suppress lithium dendrites, enabling the use of lithium metal anodes in practical devices without the inherent limitations of liquid electrolytes. A high-capacity anode and a low reduction potential allow for a lighter, thinner, and cheaper rechargeable battery.

Solid-state electrolytes include all-solid-state electrolytes and quasi-solid-state electrolytes (QSSE). All-solid-state electrolytes are further divided into inorganic solid electrolytes (ISE), solid polymer electrolytes (SPE), and composite polymer electrolytes (CPE). QSSE, also known as a gel polymer electrolyte (GPE), is an independent membrane containing a fixed amount of liquid components within a solid matrix. The ion conduction mechanisms of SPE and GPE differ significantly: SPE conducts ions through interactions with substituents on polymer chains, while GPE primarily conducts ions in solvents or plasticizers.

The solid-state electrolyte mainly includes: a lithium salt as an ion source, selected from lithium fluoride, lithium sulfide, or lithium phosphate; a matrix providing mechanical support and ion transport channels, the matrix being a polymer matrix using one or more of polyethylene oxide, polyvinylidene fluoride, polyacrylonitrile, and polyurethane; an inorganic filler for enhancing mechanical properties and ionic conductivity of the solid-state electrolyte, the inorganic filler using one or more of lithium oxide, lithium titanate, lithium phosphate, alumina, and silica, with a nanoscale particle size (1 nm to 100 nm); a rare earth element for improving lithium-ion conductivity of the solid-state electrolyte, the rare earth element using one or more of lanthanum, cerium, prascodymium, neodymium, gadolinium, erbium, lutetium, and yttrium; and a ceramic material for enhancing toughness of the solid-state electrolyte, the ceramic material using one or more of zirconia, silicon nitride, silica, titanium disulfide, and lithium sulfide.

The preparation operations for the solid-state electrolyte include: mixing inorganic ceramic oxide particles with polyimide particles to form mixed particles. The inorganic ceramic oxide particles are a mixture of lithium salts, inorganic fillers, rare earth elements, and ceramic materials. The polyimide particles form the interstitial structures in subsequent branches 110. During high-temperature curing, polyimide particles undergo imidization, releasing small molecules (e.g., water) and causing volume shrinkage. The rigidity of molecular chains hinders uniform densification of inorganic ceramic oxide particles during shrinkage, and localized stress concentration induces wrinkles or protrusions at the edges of pores formed by polyimide sublimation, ultimately forming irregular arrayed pillars, i.e., branches 110.

In some embodiments, the inorganic ceramic oxide particles may include lithium lanthanum titanium oxide/lithium lanthanum titanate (Li_{0.33}La_{0.56}TiO₃, LLTO), lithium lanthanum zirconium oxide/lithium lanthanum zirconate (Li₇La₃Zr₂O₁₂, LLZTO), or lithium bis(trifluoromethanesulfonyl)imide (C₂F₆LiNO₄S₂, LiTFSI). Representative materials for NASICON-type solid-state electrolytes include lithium aluminum titanium phosphate (Li_{1.3}Al_{0.3}Ti_{1.7}(PO₄)₃, LATP).

In some embodiments, during the operation of preparing the ceramic aerosol, the volume ratio of inorganic ceramic oxide particles to polyimide particles is 1:(1 to 10).

Forming the mixed particles into a ceramic aerosol reduces a sintering temperature for subsequent preparation of the solid-state electrolyte, lowering manufacturing costs. The resulting solid-state electrolyte exhibits uniform composition and smooth interfaces.

Nitrogen (or helium, oxygen, etc.) is used as a carrier gas to feed mixed particles into an aerosol chamber via a gas delivery device, ensuring uniform dispersion of particles and formation of the ceramic aerosol.

The ceramic aerosol is sprayed onto the substrate layer 100 to form a pre-polymer layer. Specifically, an LLZTO solid-state electrolyte sheet serves as the substrate layer 100, a pressure in the deposition chamber is set to 8 Pa to 12 Pa, a distance from a nozzle to a surface of the substrate layer is 9 mm to 11 mm, and a spray angle is 85° to 95°. The aerosol is sprayed onto the surface of the substrate layer 100 via the nozzle using the carrier gas at a flow rate of 20 L/min to 22 L/min for a deposition time of 1 h to 2 h. This yields a solid-state electrolyte sheet with deposited mixed particles, i.e., a pre-polymer layer.

The mechanism for forming the pre-polymer layer via aerosol involves two stages. In an initial stage, collisions of primary micro-nano particles with the substrate rapidly form an anchor layer on the substrate surface, and interface damage between the deposited film and the substrate increases surface roughness. In a secondary stage, after forming the initial anchor layer, reducing carrier gas flow slows film growth. Particles deposited on the anchor layer gradually smoothen and densify the surface, and through repeated fragmentation, deformation, and collision of primary particles, a dense deposited film (i.e., the pre-polymer layer) is ultimately formed. This film formation phenomenon is also referred as to the room- temperature collision bonding principle.

It should be noted that the LLZTO solid-state electrolyte sheet may be a conventional solid-state electrolyte sheet. Embodiments of the present disclosure represent further optimization of the conventional solid-state electrolyte sheet.

The heat treatment operation may include: placing the substrate layer 100 with the pre-polymer layer in a high-temperature reactor, and calcining at 900° C. for 1 h to 3 h to remove polyimide particles while fusing inorganic ceramic oxide particles, thereby forming a substrate layer with branches 110.

The mechanism is as follows: inorganic ceramic oxide particles and polyimide (PI) particles exhibit significant differences in density, particle size distribution, and surface energy. The polyimide particles typically possess thermal decomposition properties and act as a sacrificial template, while the inorganic ceramic oxide particles exhibit high structural stability. When ceramic aerosol is deposited via high-velocity spraying, particles impact the substrate layer 100 due to inertia, causing a “splattering effect.” Large-sized particles preferentially deposit, forming localized accumulations; small particles fill gaps under airflow disturbance but are elastically hindered by PI particles, creating a “micro-region arch bridge” structure that results in the initial uneven topography of the pre-polymer layer. Furthermore, during heat treatment at 300° C. to 500° C., PI particles undergo staged decomposition (releasing gases such as carbon dioxide and formaldehyde). The decomposition kinetics compete with the sintering behavior of ceramic particles. Gases generated from PI decomposition escape through gaps between ceramic particles, forming “dendritic channels” in the ceramic skeleton. Ceramic particles undergo surface sintering (neck growth) at a high temperature, while PI decomposition zones experience volumetric collapse. The difference in shrinkage rates (ceramic: ˜3% to 5%, PI decomposition zone: >20%) induces tensile stress concentration at interfaces, forcing pore wall edges to curl upward and form protrusions, i.e., branches 110.

In some embodiments, process parameters of the heat treatment include: a reaction temperature of 500° C. to 1000° C., a calcination time of 0.8 h to 1.2 h, and a sweeping gas flow rate of 0.5 L/min to 3 L/min.

An active material, a conductive agent, a binder, and a dispersion solution are uniformly mixed to obtain a coating slurry. The coating slurry is applied onto one side of substrate layer 100, where the coating slurry flows into gaps between the branches 110. Drying treatment is performed to convert the coating slurry into an active layer 101, where the substrate layer 100 and the branches 110 collectively form the solid-state electrolyte.

In some embodiments, if the active layer is between the positive electrode current collector and the substrate layer, the active material is a positive electrode material; if the active layer is between the negative electrode current collector and the substrate layer, the active layer is a negative electrode material. Taking as an example the active layer being the positive electrode material which is lithium iron phosphate (LFP), referring to FIG. 2, LFP, carbon black, and PVDF in a ratio of (92 wt % to 98 wt %):(0.6 wt % to 4 wt %):(1.4 wt % to 4 wt %) are mixed. N-Methyl-2-pyrrolidone (NMP) is added to achieve 50% solid content in the slurry. Stirring operation is performed under a negative pressure for 3 h to obtain an LFP slurry. Using the solid-state electrolyte layer as the substrate layer 100, the LFP slurry is applied with a scraper. Ultrasonic treatment is performed for 5 min to enhance slurry infiltration between the branches 110, then drying is performed. The applying-ultrasonication-drying cycle is repeated three times to form an interlocked structure with irregular protrusions, i.e., the substrate layer 100 with the branches 110.

In some embodiments, the branches 110 contain pores, and the coating slurry flows into the pores. After drying treatment, at least a portion of the active layer 101 is embedded within the pores. Thus, the coating slurry located between pores enhances adhesion between the active layer 101 and the solid-state electrolyte, and the active layer 101 within the pores improves electrical conductivity.

In some embodiments, the dispersion solution includes a wetting agent configured to facilitate the flow of the coating slurry into the pores. The wetting agent can improve the wettability of the coating slurry on the solid-state electrolyte, increasing the contact area between the coating slurry and solid-state electrolyte, thereby enhancing interfacial contact performance between the solid-state electrolyte and the active layer 101.

In some embodiments, ultrasonic treatment is performed before drying to enable the coating slurry to fill the pores. The ultrasonic treatment has an ultrasonic treatment time of 3 min to 15 min, and an ultrasonic frequency of 20 kHz to 5 MHz. This improves contact performance between the active layer 101 and the solid-state electrolyte.

FIG. 4 is a second schematic structure diagram of a solid-state secondary battery according to embodiments of the present disclosure. FIG. 4 only illustrates part of the solid-state electrolyte layer. The arrangement with the positive and negative electrode sheets may may refer to FIG. 2, and subsequent partial cross-sectional views may also refer to FIG. 2.

In some embodiments, referring to FIG. 4, forming the coating slurry includes: uniformly mixing an active material, nano inorganic ceramic oxide particles, a conductive agent, a binder, and a dispersion solution to obtain a second mixed solution; subjecting the second mixed solution to high-speed dispersion under a negative pressure for 4 h to 6 h to obtain the coating slurry, with a viscosity range of 5000 mPa·s to 20000 mPa·s. The mass ratio of the active material, nano inorganic ceramic oxide particles, conductive agent, and binder is (73 wt % to 93 wt %):(5 wt % to 18 wt %):(0.6 wt % to 4.5 wt %):(1.4 wt % to 4.5 wt %).

The second mixed solution composed of the active material, nano inorganic ceramic oxide particles, conductive agent, and binder in the coating slurry has an average particle size of less than 20 μm.

The active layer being the positive electrode material which is LFP is taken as an example. Mix LFP, nano lithium lanthanum zirconium oxide (LLhZO) particles, carbon black, and PVDF in a ratio of (73 wt % to 93 wt %):(5 wt % to 18 wt %):(0.6 wt % to 4.5 wt %):(1.4 wt % to 4.5 wt %). Add NMP to achieve 60% solid content in the slurry. Perform high-speed dispersion under a negative pressure for 5 h to obtain a mixed slurry with viscosity ranging from 5000 mPa·s to 20000 mPa·s and fineness below 20 μm. Pump the mixed slurry into a buffer tank, feed through a delivery pipe to a coating die, and apply onto an LLZO solid-state electrolyte sheet at a speed of 5 m/min. Transport the coated sheet via a conveyor belt into a multi-zone oven with a temperature set between 80° C. and 130° C. After drying, the self-aggregation tendency of nano LLZO particles in the slurry converts the nano LLZO particles into secondary sphere aggregates 102 in the coating layer.

The mechanism involves: during 5 h of high-speed dispersion under a negative pressure, shear forces break down hard agglomerates of LLZO nanoparticles for temporary uniform dispersion. At this time, PVDF molecular chains fully extend in an NMP solvent, partially adsorbing onto particle surfaces to form steric hindrance layers that delay re-agglomeration. The 60% or higher solid content of the slurry indicates high slurry viscosity, which restricts particle movement but also intensifies the “crowding effect,” causing pre-aggregation of LLZO particles in local areas due to physical extrusion. In subsequent drying, the high surface energy of the LLZO nanoparticles drives exposed LLZO nanoparticles to aggregate upon solvent evaporation to so as reduce total surface area and system free energy, thus forming secondary sphere aggregates 102.

FIG. 5 is a third schematic structure diagram of a solid-state secondary battery according to embodiments of the present disclosure.

Referring to FIG. 5, the coating slurry includes an active material coated with Ga-LLZO. Forming the active material includes: uniformly mixing Ga-LLZO particles, active particles, and a solution to form a first mixed solution; drying the first mixed solution to form a first precursor; calcining the first precursor to form the Ga-LLZO-coated active material. The mass ratio of Ga-LLZO particles to active particles is (0.5 wt % to 2 wt %):(8 wt % to 9.5 wt %).

It should be noted that if the active material is the positive electrode active material, the active material may be a lithium source material; and if the active material is the negative electrode active material, the active material may be graphite.

The active material being LFP is used as an example. Uniformly mix nano Ga-LLZO particles and LFP in a ratio of (0.5 wt % to 2 wt %):(8 wt % to 9.5 wt %) in an NMP solvent. After drying to remove NMP, calcine at 700° C. for 30 min to 60 min to form a Ga-LLZO-coated LFP structure. Blend the Ga-LLZO-coated LFP structure, carbon black, and PVDF in a ratio of (92 wt % to 98 wt %):(0.6 wt % to 4 wt %):(1.4 wt % to 4 wt %), add NMP to achieve 60% solid content in the slurry, and stir under a negative pressure for 3 h to 5 h to obtain an LFP slurry. Extrusion-apply the LFP slurry onto an LLZO solid-state electrolyte sheet as the substrate layer, and then dry to form a surface-coated interlocked structure. The surface-coated interlocked structure is the Ga-LLZO-coated active material 103.

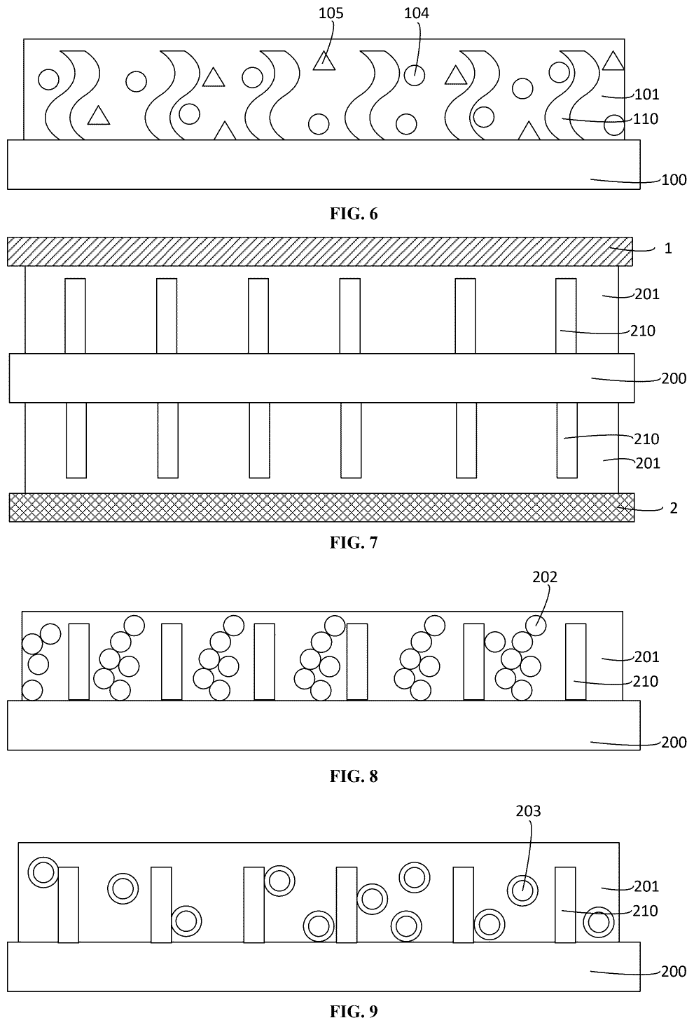

FIG. 6 is a fourth schematic structure diagram of a solid-state secondary battery according to embodiments of the present disclosure.

In some embodiments, referring to FIG. 6, the coating slurry includes an active material which is graphite. After forming the solid-state electrolyte, the method further includes: uniformly mixing lithium bis(trifluoromethanesulfonyl)imide, poly(ethylene glycol)methyl ether methacrylate, poly(ethylene glycol)dimethacrylate, a photoinitiator, graphite, and conductive carbon black to obtain a curing solution; and immersing the solid-state electrolyte into the curing solution and performing curing treatment on the solid-state electrolyte with the curing solution. The mass ratio of lithium bis(trifluoromethanesulfonyl)imide, poly(ethylene glycol)methyl ether methacrylate, poly(ethylene glycol)dimethacrylate, photoinitiator, graphite and conductive carbon black is (35 wt % to 55 wt %):(30 wt % to 50 wt %):(1 wt % to 7.5 wt %):(1.5 wt % to 4.5 wt %):(2 wt % to 7 wt %): (1 wt % to 3 wt %).

In pure water, mix graphite, carbon black, CMC, and SBR in a ratio of (92 wt % to 96 wt %):(1 wt % to 3 wt %):(0.5 wt % to 2.5 wt %):(1.5 wt % to 3.5 wt %) to achieve 50% solid content in the slurry. Stir under a negative pressure for 3 h to obtain a graphite slurry. Extrusion-apply the graphite slurry onto an LLZO solid-state electrolyte sheet as the substrate layer, then dry to obtain a graphite-coated solid-state electrolyte sheet. Immerse this solid-state electrolyte sheet into the curing solution and let it stand for 30 min to 60 min. In the curing solution, a mass ratio of lithium bis(trifluoromethanesulfonyl)imide, poly(ethylene glycol)methyl ether methacrylate, poly(cthylene glycol)dimethacrylate, photoinitiator, graphite, and conductive carbon black is (35 wt % to 55 wt %):(30 wt % to 50 wt %):(1 wt % to 7.5 wt %):(1.5 wt % to 4.5 wt %):(2 wt % to 7 wt %):(1 wt % to 3 wt %). After standing, take out the solid-state electrolyte sheet and cure it under UV for 3 min to 6 min to form an interlocked structure with a cross-linked network.

The mechanism involves: the PEG-based polymer network 104 (formed by poly(ethylene glycol)methyl ether methacrylate and poly(ethylene glycol)dimethacrylate) interpenetrates with the graphite/carbon black conductive pathway 105, creating a bi-continuous phase structure. The polymer network conducts ions, while the carbon black network conducts electrons (carbon black self-aggregates to form long-range conductive segments that build a conductive network), enhancing the ion/electron conduction capability of the active material layer. After curing, a polymer film forms on the surface of the active material layer, enhancing the mechanical strength of the solid-state electrolyte. The addition of conductive materials increases the electron conductivity of the current collector.

In some embodiments, the active layer serves as an active layer of the positive electrode sheet. In this case, the current collector is a positive electrode current collector. Forming the positive electrode sheet includes: providing the positive electrode current collector on the surface of the active layer 101; performing hot pressing on the solid-state electrolyte and positive electrode current collector, where the active layer 101 and the positive electrode current collector constitute positive electrode sheet 1.

In some embodiments, the active layer serves as part of an active layer of the positive electrode sheet. The positive electrode sheet further has a positive sub-active layer. The current collector is a positive electrode current collector. Forming the positive electrode sheet includes: preparing a positive sub-active layer on the surface of the active layer 101; providing the positive electrode current collector on the surface of the positive sub-active layer; and performing hot pressing on the solid-state electrolyte and positive electrode current collector, where the positive sub-active layer, active layer 101, and positive electrode current collector constitute the positive electrode sheet 1. The active layer 101 not only acts as a positive active layer but also as a contact enhancement layer, improving contact performance and enabling tight interfacial contact between the solid-state electrolyte layer and positive electrode sheet during hot pressing.

Similarly, the active layer can serve as an active layer of the negative electrode sheet. In this case, the current collector is a negative electrode current collector. Forming the negative electrode sheet includes: providing the negative electrode current collector positioned on the surface of the active layer 101; and performing hot pressing on the solid-state electrolyte and negative electrode current collector, where the active layer 101 and the negative electrode current collector constitute the negative electrode sheet 2.

In some embodiments, the active layer serves as part of the active layer of the negative electrode sheet. The negative electrode sheet further has a negative sub-active layer. The current collector is a negative electrode current collector. Forming the negative electrode sheet includes: preparing the negative sub-active layer on the surface of the active layer 101; providing the negative electrode current collector on the surface of the negative sub-active layer; and performing hot pressing on the solid-state electrolyte and negative electrode current collector, where the negative sub-active layer, active layer 101, and negative electrode current collector constitute the negative electrode sheet 2. The active layer 101 not only acts as a negative active layer but also as a contact enhancement layer, improving contact performance and enabling tight interfacial contact between the solid-state electrolyte layer and the negative electrode sheet during hot pressing

The preparation method further includes: welding electrode tabs to connection tabs, connecting the other end of the connection tabs to terminal posts; and securing a top cover to the battery casing. The connection tabs are located within the cavity, and the terminal posts penetrate the top cover.

The connection tabs include at least a first connection tab and a second connection tab. The terminal posts include a positive terminal post and a negative terminal post. The first connection tab electrically connects the positive electrode tab of the positive electrode sheet to the positive terminal post, while the second connection tab electrically connects the negative electrode tab of the negative electrode sheet to the negative terminal post.

In the method for preparing the solid-state secondary battery provided by the embodiments of the present disclosure, the solid-state electrolyte is prepared so that branches 110 are formed on the surface of the solid-state electrolyte and are positioned between the positive electrode current collector and the substrate layer 100 and/or between the negative electrode current collector and the substrate layer 100, enabling the positive active layer of the positive electrode sheet 1 to interlock and be mutually embed with the solid-state electrolyte, and the negative active layer of the negative electrode sheet 2 to interlock and be mutually embed with the solid-state electrolyte, thereby increasing contact area and reducing battery internal resistance. Furthermore, the aerosol process is adopted to form branches 110 on the surface of the substrate layer 100, and subsequent formation of the active layer 101 in gaps between the branches 110 allows the active layer 101 to serve dual functions: as a positive/negative active layer and as a contact enhancement layer to improve contact performance. During subsequent rolling pressing operations, this ensures tight interfacial contact between the solid-state electrolyte layer and the positive/negative electrode sheets 1, 2.

According to some embodiments, another aspect of the present disclosure further provides a solid-state secondary battery including: a battery casing with an internal cavity; and a bare cell located in the cavity. The bare cell includes a positive electrode sheet 1, a solid-state electrolyte, and a negative electrode sheet 2 stacked in sequence. The solid- state electrolyte includes: a substrate layer 100 and multiple branches 110, where gaps exist between adjacent branches 110, and the branches 110 are located on at least one side of the substrate layer 100. The bare cell further includes an active layer 101 located on a surface of the substrate layer 100 and in the gaps. The active layer is positioned between the substrate layer 100 and at least one of a positive electrode current collector and a negative electrode current collector. The active layer between the substrate layer 100 and the positive electrode current collector constitutes part of the positive active layer, and forms the positive electrode sheet 1 together with the positive electrode current collector. The active layer between the substrate layer 100 and the negative electrode current collector constitutes part of the negative active layer, and forms the negative electrode sheet 2 together with the negative electrode current collector.

In some embodiments, the branches 110 contain pores, and a portion of the active layer 101 is embedded within the pores.

In some embodiments, the active layer 101 includes a Ga-LLZO coated active material.

The beneficial effects of the embodiments of the present disclosure are further illustrated below through embodiments and comparative examples.

### Embodiment 1

Mix LLZTO particles and PI particles uniformly in a volume ratio of 1:2 to obtain mixed particles. Use nitrogen as carrier gas to feed the mixed particles into an aerosol chamber via a gas delivery device, ensuring uniform dispersion. Use an LLZTO solid-state electrolyte sheet as the substrate layer. Set a pressure in the deposition chamber to 10 Pa, a distance from the nozzle to substrate surface is 10 mm, and a spray angle is 90°. Spray the aerosol onto the surface of substrate layer 100 via the nozzle using the carrier gas at 20 L/min flow rate for a deposition time of 1 h, forming a pre-polymer layer with mixed particles deposited. Place the pre-polymer layer in a high-temperature reactor and calcine at 900° C. for 1 h to remove PI particles while fusing LLZTO particles, forming a precursor with branches. Mix LFP, carbon black, and PVDF in a ratio of 94 wt %:3 wt %:3 wt %. Add NMP to achieve 50% solid content in the slurry. Stir under a negative pressure for 3 h to obtain an LFP slurry. Using the solid-state electrolyte layer as the substrate layer, apply the LFP slurry with a scraper, ultrasonicate for 5 min to enhance infiltration between arrayed pillars, and dry. Repeat the applying-ultrasonication-drying cycle three times to obtain a solid-state electrolyte with branches.

A positive electrode sheet and a negative electrode sheet are provided, where the active layer serves as the positive active layer of the positive electrode sheet. The negative electrode sheet, the solid-state electrolyte, and the positive electrode sheet are stacked in sequence, followed by hot pressing to obtain a bare cell, the bare cell is placed into a battery casing, and the battery casing is encapsulated to obtain the solid-state secondary battery.

Embodiment 2: Differing from Embodiment 1 in that the volume ratio of LLZTO particles to PI particles is 1:1.

Embodiment 3: Differing from Embodiment 1 in that the volume ratio of LLZTO particles to PI particles is 1:10.

Embodiment 4: Differing from Embodiment 1 in that the active layer includes a positive active layer of the positive electrode sheet and a negative active layer of the negative electrode sheet.

Embodiment 5: Differing from Embodiment 1 in that the pre-polymer layer is placed in a high-temperature reactor and calcined at 500° C. for 1 h to remove PI particles while fusing LLZTO particles, forming the substrate layer with branches.

Embodiment 6: Differing from Embodiment 1 in that the pre-polymer layer is placed in a high-temperature reactor and calcined at 1000° C. for 1 h to remove PI particles while fusing LLZTO particles, forming the substrate layer with branches.

### Embodiment 7

Differing from Embodiment 1 in the preparation of active layer 101: Mix LFP, nano LLZO particles, carbon black, and PVDF in a ratio of 80 wt %:14 wt %:3 wt %:3 wt %. Add NMP to achieve 60% solid content of the slurry. Perform high-speed dispersion under a negative pressure for 5 h to obtain a mixed slurry with a viscosity of 10000 mPa·s and a fineness of less than 20 μm. Applying: Pump the mixed slurry into a buffer tank, feed through a delivery pipe to a coating die, and apply onto an LLZO solid-state electrolyte sheet at 5 m/min. Transport the coated sheet via a conveyor belt into a multi-zone oven set at 80° C. to 130° C. After drying, the self-aggregation tendency of nano LLZO particles in the slurry forms the structure shown in FIG. 4.

Embodiment 8: Differing from Embodiment 7 in that the mass ratio of LFP, nano LLZO particles, carbon black, and PVDF is 76 wt %:18 wt %:3 wt %:3 wt %.

Embodiment 9: Differing from Embodiment 7 in that the mass ratio of LFP, nano LLZO particles, carbon black, and PVDF is 89 wt %:5 wt %:3 wt %:3 wt %.

### Embodiment 10

Uniformly mix nano Ga-LLZO particles and LFP in a ratio of 1 wt %: 9 wt % in an NMP solvent. After drying to remove NMP, calcine at 700° C. for 30 min to form a Ga-LLZO-coated LFP structure. Blend the Ga-LLZO-coated LFP structure, carbon black, and PVDF in a ratio of 94 wt %:3 wt %:3 wt %, add NMP to achieve 60% solid content in the slurry, stir under a negative pressure for 3 h to obtain an LFP slurry. Extrusion-apply the LFP slurry onto an LLZO solid-state electrolyte sheet as the substrate layer, then dry to form a surface-coated interlocked structure as shown in FIG. 5.

Embodiment 11: Differing from Embodiment 10 in that the mass ratio of nano Ga-LLZO particles to LFP is 2 wt %: 8 wt %.

Embodiment 12: Differing from Embodiment 10 in that the mass ratio is 0.5 wt %: 9.5 wt %.

Embodiment 13: Differing from Embodiment 10 in that the mass ratio of Ga-LLZO-coated LFP structure, carbon black, and PVDF is 98 wt %:0.6 wt %:1.4 wt %.

Embodiment 14: Differing from Embodiment 10 in that the mass ratio is 92 wt %: 4 wt %: 4 wt %.

### Embodiment 15

In pure water, mix graphite, carbon black, CMC, and SBR (94 wt %: 2 wt %: 1.5 wt %: 2.5 wt %) to achieve 50% solid content in the slurry. Stir under a negative pressure for 3 h to obtain a graphite slurry. Extrusion-apply the graphite slurry onto an LLZO solid-state electrolyte sheet as the substrate layer, then dry to obtain a graphite-coated solid-state electrolyte sheet. Immerse this solid-state electrolyte sheet into the curing solution and let it stand for 30 min. In the curing solution, a mass ratio of LiFSI, PEGMA, PEGDMA, D1173, graphite, and SP is 45 wt %:40 wt %:5 wt %:3 wt %:5 wt %:2 wt %. After standing, take out the solid-state electrolyte sheet and cure it under UV for 3 min to form an interlocked structure with a cross-linked network as shown in FIG. 6.

Embodiment 16: Differing from Embodiment 15 in that the mass ratio of LiFSI, PEGMA, PEGDMA, D1173, graphite, and SP is 35 wt %:50 wt %:5 wt %:3 wt %:5 wt %: 2 wt %.

Embodiment 17: Differing from Embodiment 15 in that the mass ratio of LiFSI, PEGMA, PEGDMA, D1173, graphite, and SP is 55 wt %:30 wt %:5 wt %:3 wt %:5 wt %: 2 wt %.

Comparative Example 1: The solid-state electrolyte is an LLZTO solid-state electrolyte sheet.

Comparative Example 2: Differing from Embodiment 1 in that the volume ratio of LLZTO particles to PI particles is 1:0.1.

Comparative Example 3: Differing from Embodiment 1 in that the volume ratio of LLZTO particles to PI particles is 1:20.

Comparative Example 4: Differing from Embodiment 1 in that the reactor temperature is 300° C.

Comparative Example 5: Differing from Embodiment 1 in that the reactor temperature is 1500° C.

Comparative Example 6: Differing from Embodiment 7 in that the mass ratio of LFP, nano LLZO particles, carbon black, and PVDF is 64 wt %:30 wt %:3 wt %:3 wt %.

Comparative Example 7: Differing from Embodiment 7 in that the mass ratio of LFP, nano LLZO particles, carbon black, and PVDF is 93 wt %:1 wt %:3 wt %:3 wt %.

Comparative Example 8: Differing from Embodiment 10 in that the mass ratio of nano Ga-LLZO particles to LFP is 3 wt %:7 wt %.

Comparative Example 9: Differing from Embodiment 10 in that the mass ratio of nano Ga-LLZO particles to LFP is 0.2 wt %:9.8 wt %.

Comparative Example 10: Differing from Embodiment 10 in that the mass ratio of Ga-LLZO-coated LFP structure, carbon black, and PVDF is 90 wt %:5 wt %:5 wt %.

Comparative Example 11: Differing from Embodiment 10 in that the mass ratio of Ga-LLZO-coated LFP structure, carbon black, and PVDF is 99 wt %:0.5 wt %:0.5 wt %.

Comparative Example 12: Differing from Embodiment 15 in that the mass ratio of LiFSI, PEGMA, PEGDMA, D1173, graphite and SP is 25 wt %:60 wt %:5 wt %:3 wt %:5 wt %:2 wt %.

Comparative Example 13: Differing from Embodiment 15 in that the mass ratio of LiFSI, PEGMA, PEGDMA, D1173, graphite and SP is 65 wt %:20 wt %:5 wt %:3 wt %:5 wt %:2 wt %.

The solid-state secondary batteries prepared in the above embodiments and comparative examples were sequentially subjected to electrochemical performance testing, with results summarized in Table 1.

Electrochemical performance: Test temperature is 25±2° C., charge with a constant current at 0.5 C to 3.65 V, rest for 10 min, and then discharge with a constant current at 0.5 C to a voltage of 2.5 V (this capacity is recorded as initial capacity for rate capability test). Recharge with a constant current at 1 C to 3.65 V, rest for 10 min, and then discharge with a constant current at 1 C to a voltage of 2.5 V (this capacity is recorded as 1 C rate capacity). C-rate (abbreviated as C) denotes a value relative to the battery's rated capacity. For example, if a battery has a rated capacity of 200 Ah, 1 C is equivalent to a 200 A charge/discharge rate. Thus, 0.5 C indicates full charge in 2 hours, and 1 C indicates full charge in 1 hour.

TABLE 1

| | Initial | Rate |
|---|---|---|
| Item | capacity/Ah | capacity/Ah |
| Embodiment 1 | 3.02 | 2.83 |
| Embodiment 2 | 3.04 | 2.82 |
| Embodiment 3 | 2.99 | 2.74 |
| Embodiment 4 | 3.05 | 2.96 |
| Embodiment 5 | 2.97 | 2.76 |
| Embodiment 6 | 3.03 | 2.87 |
| Embodiment 7 | 3.05 | 2.85 |
| Embodiment 8 | 2.95 | 2.81 |
| Embodiment 9 | 3.12 | 2.95 |
| Embodiment 10 | 3.08 | 2.89 |
| Embodiment 11 | 2.93 | 2.81 |
| Embodiment 12 | 3.12 | 2.96 |
| Embodiment 13 | 3.09 | 2.90 |
| Embodiment 14 | 3.07 | 2.81 |
| Embodiment 15 | 3.09 | 2.99 |
| Embodiment 16 | 3.09 | 2.95 |
| Embodiment 17 | 3.13 | 2.99 |
| Comparative | 3.00 | 2.67 |
| example 1 | | |
| Comparative | 2.97 | 2.66 |
| Example 2 | | |
| Comparative | 2.97 | 2.66 |
| Example 3 | | |
| Comparative | 2.69 | 2.02 |
| Example 4 | | |
| Comparative | 3.02 | 2.74 |
| Example 5 | | |
| Comparative | 2.54 | 2.48 |
| Example 6 | | |
| Comparative | 3.00 | 2.82 |
| Example 7 | | |
| Comparative | 2.61 | 2.38 |
| Example 8 | | |
| Comparative | 2.95 | 2.76 |
| Example 9 | | |
| Comparative | 2.79 | 2.64 |
| Example 10 | | |
| Comparative | 2.81 | 2.63 |
| Example 11 | | |
| Comparative | 3.03 | 2.61 |
| Example 12 | | |
| Comparative | 3.00 | 2.78 |
| Example 13 | | |

Referring to test data in Table 1: Electrochemical tests of Embodiments 1 to 6 and Comparative Examples 1 to 5 demonstrate that the solid-state electrolyte of the present disclosure can improves rate capacity compared with the conventional solid-state electrolytes. Electrochemical tests of embodiments 7 to 17 and Comparative Examples 6 to 13 demonstrate that the solid-state electrolyte configured with branched structures in the embodiments of the present disclosure can enhance rate capacity and initial capacity.

Correspondingly, another embodiment of the present disclosure provides a method for preparing a solid-state electrolyte, which differs from the above embodiments in modified process operations leading to a different structure of the obtained solid-state electrolyte. Technical features identical or corresponding to those in the above embodiments are not repeated here.

Referring to FIG. 7, the method includes: in an argon-protected glove box, mixing a lithium metal compound, a lanthanum metal compound, and a zirconium metal compound at a molar ratio of (10-11):(2.5-3.5):(1.5-2.5) to obtain a metal precursor, with oxygen and water content each below 1 ppm; using an LLZO solid-state electrolyte sheet as the substrate layer 200, providing a baffle having arrayed holes on the surface of the substrate layer 200; evaporating the pre-mixed metal precursor using a laser for deposition. The deposition temperature is set to 700° C. to 800° C., a pressure in the deposition chamber is 1 kPa to 1.5 kPa. Argon is used as a carrier gas at a flow rate of 3 standard liters/min to 3.5 standard liters/min. Oxygen is used as a reaction gas at a flow rate of 2 standard liters/min to 2.5 standard liters/min. The reaction time is 30 min to 60 min. After the reaction, heat preservation is performed for 15 min to 25 min, and then cooling is performed at 1° C./s to 1.5° C./s to obtain a precursor body with array pillars 210 grown on the surface.

The active material, conductive agent, binder, and dispersion solution are uniformly mixed to obtain the first coating slurry. The first coating slurry is applied onto the pre-polymer, where the first coating slurry flows into gaps between some arrayed pillars 210, and the solid-state electrolyte is formed after drying, with the coating slurry converted to the active layer 201.

In some embodiments, if the active layer is located between the positive current collector and the substrate layer, the active material is a positive electrode material; and if the active layer is located between the negative electrode current collector and the substrate layer, the active material is a negative electrode material.

In some embodiments, LFP, carbon black, and PVDF in a ratio of (92 wt % to 96 wt %):(2 wt % to 4 wt %):(2 wt % to 4 wt %) are mixed, and then NMP is added to achieve 50% solid content in the slurry. Stirring operation is performed under a negative pressure for 3 h to obtain an LFP slurry. Using the solid-state electrolyte layer as the substrate layer, the LFP slurry is applied with a scraper. Ultrasonic treatment is performed for 5 min to enhance slurry infiltration between arrayed pillars, and drying is performed. The coating-ultrasonication-drying cycle is repeated three times to form an interlocked structure with arrayed pillars.

In some embodiments, the lithium metal compound may be LiC₁₁H₁₉O₂, the lanthanum metal compound may be La(C₅H₇O₂)₃·4H₂O, and the zirconium metal compound may be Zr(C₅H₇O₂)₄.

The mechanism involves: template-guided growth of LLZO arrayed pillars via laser deposition. A laser (e.g., CO₂ laser, wavelength of 8 μm to 12 μm) focuses on the precursor target, vaporizing organometallic compounds at an instantaneous high temperature (>2000° C.). Vaporized precursors are transported by carrier gas (Ar) to the LLZO substrate layer. Micro-pores (diameter of about 50 μm, and spacing of about 100 μm) on the baffle plate confine deposition zones. After passing through micro-pores, limited diffusion of vaporized precursors creates localized concentration gradients on the substrate surface, driving pillar growth. Vaporized precursors react with O₂ to form Li—La—Zr—O aerosol, undergoing heterogeneous nucleation (activation energy of about 150 KJ/mol) on the LLZO surface. Pillar growth preferentially occurs along the (110) crystal plane (due to anisotropic surface energy difference), ultimately forming single-crystal LLZO arrayed pillars. Combined with multi-operation ultrasound-assisted applying and PVDF binder phase modulation, a three-dimensional interlocked LFP-LLZO structure is successfully constructed. This architecture enables synergistic optimization of high energy density, low impedance, and long cycle life through vertical ion channels, three-dimensional electron networks, and multi-level stress buffering mechanisms.

Prepare the positive electrode sheet 1 and the negative electrode sheet 2 includes: providing a current collector, where the active layer 101 is between the current collector and the substrate layer 100; stacking the negative electrode sheet, the solid-state electrolyte, and the positive electrode sheet in sequence, followed by hot pressing to form a bare cell; placing the bare cell into a battery casing, and encapsulating the battery casing to obtain the solid-state secondary battery.

FIG. 8 is a sixth schematic structure diagram of a solid-state secondary battery according to embodiments of the present disclosure.

In some embodiments, referring to FIG. 8, forming the first coating slurry includes: uniformly mixing an active material, nano inorganic ceramic oxide particles, a conductive agent, a binder, and a dispersion solution to obtain a second mixed solution; subjecting the second mixed solution to high-speed dispersion under a negative pressure for 4 h to 6 h to obtain the coating slurry with a viscosity of 5000 mPa·s to 20000 mPa·s and a particle size of less than 20 μm. The mass ratio of the active material, nano inorganic ceramic oxide particles, conductive agent, and binder is (73 wt % to 93 wt %):(5 wt % to 18 wt %):(0.6 wt % to 4.5 wt %):(1.4 wt % to 4.5 wt %).

Mix LFP, nano LLZO particles, carbon black, and PVDF in a ratio of (73 wt % to 93 wt %): (5 wt % to 18 wt %):(0.6 wt % to 4.5 wt %):(1.4 wt % to 4.5 wt %). Add NMP to achieve 60% solid content in the slurry. Perform high-speed dispersion under a negative pressure for 5 h to obtain a mixed slurry with a viscosity of 5000 mPa·s to 20000 mPa·s and a fineness of less than 20 μm. Pump the mixed slurry into a buffer tank, feed through a delivery pipe to a coating die, and apply onto an LLZO solid-state electrolyte sheet at a speed of 5 m/min. Transport the coated sheet via a conveyor belt into a multi-zone oven with a temperature set between 80° C. and 130° C. After drying, the self-aggregation tendency of nano LLZO particles in the slurry converts the nano LLZO particles into secondary sphere aggregates 102 in the coating layer.

FIG. 9 is a seventh schematic structure diagram of a solid-state secondary battery according to embodiments of the present disclosure.

Referring to FIG. 9, the active material is Ga-LLZO-coated active material. Forming the active material layer includes: uniformly mixing Ga-LLZO particles, active particles, and a first dispersion solution to form a first mixed solution; drying the first mixed solution to form a first precursor; calcining the first precursor to form a Ga-LLZO-coated active material. The mass ratio of Ga-LLZO particles to active particles is (0.5 wt % to 2 wt %):(8 wt % to 9.5 wt %). If the active material is the positive electrode active material, the active material may be a lithium source material; and if the active material is the negative electrode active material, the active material may be graphite.

Uniformly mix nano Ga-LLZO particles and LFP in a ratio of (0.5 wt % to 2 wt %):(8 wt % to 9.5 wt %) in an NMP solvent. After drying to remove NMP, calcine at 700° C. for 30 to 60 min to form a Ga-LLZO-coated LFP structure. Blend the Ga-LLZO-coated LFP structure, carbon black, and PVDF in a ratio of (92 wt % to 98 wt %):(0.6 wt % to 4 wt %):(1.4 wt % to 4 wt %), add NMP to achieve 60% solid content in the slurry, and stir under a negative pressure for 3 h to 5 h to obtain an LFP slurry. Extrusion-apply the LFP slurry onto an LLZO solid-state electrolyte sheet as the substrate layer, and then dry to form a surface-coated interlocked structure. The surface-coated interlocked structure is the Ga-LLZO-coated active material 203.

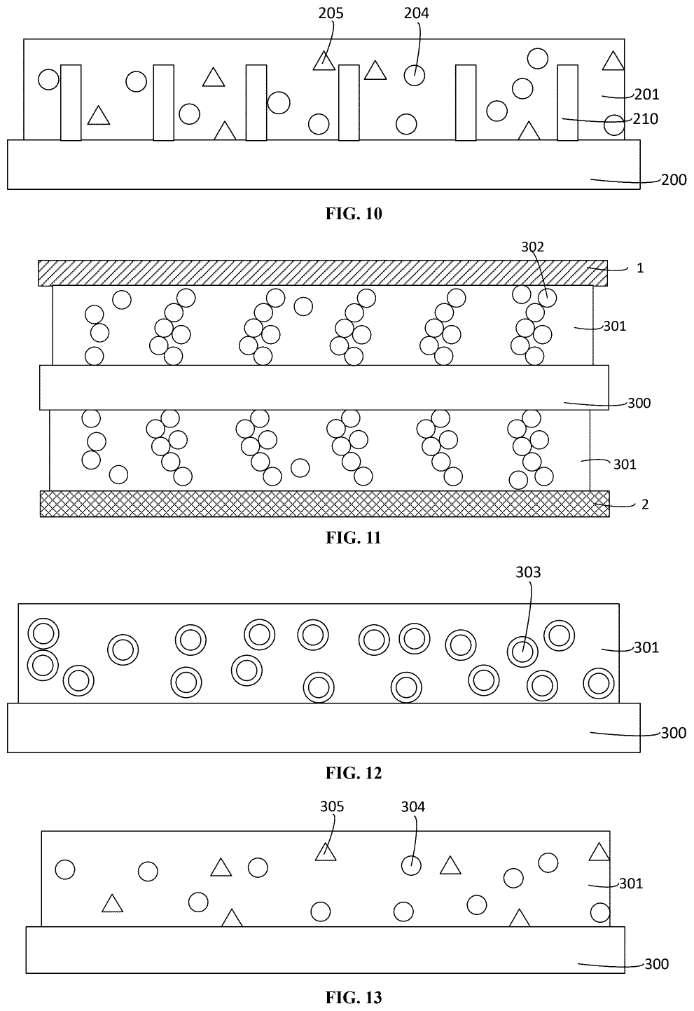

FIG. 10 is an eighth schematic structure diagram of a solid-state secondary battery according to embodiments of the present disclosure.

In some embodiments, referring to FIG. 10, the active material is graphite. After forming the solid-state electrolyte, the method further includes: uniformly mixing lithium bis(fluorosulfonyl)imide, poly(cthylene glycol)methyl ether methacrylate, poly(ethylene glycol)dimethacrylate, a photoinitiator, graphite, and conductive carbon black to obtain a curing solution; immersing the solid-state electrolyte into the curing solution and performing curing treatment. The mass ratio of lithium bis(fluorosulfonyl)imide, poly(ethylene glycol)methyl ether methacrylate, poly(ethylene glycol)dimethacrylate, photoinitiator, graphite and conductive carbon black is (35 wt % to 55 wt %):(30 wt % to 50 wt %):(1 wt % to 7.5 wt %):(1.5 wt % to 4.5 wt %):(2 wt % to 7 wt %):(1 wt % to 3 wt %).

In pure water, mix graphite, carbon black, CMC, and SBR in a ratio of (92 wt % to 96 wt %):(1 wt % to 3 wt %):(0.5 wt % to 2.5 wt %):(1.5 wt % to 3.5 wt %) to achieve 50% solid content in the slurry. Stir under a negative pressure for 3 h to obtain a graphite slurry. Extrusion-apply the graphite slurry onto an LLZO solid-state electrolyte sheet as the substrate layer, and then dry to form a graphite-coated solid-state electrolyte sheet. Immerse this solid-state electrolyte sheet into the curing solution and let it stand for 30 min to 60 min. In the curing solution, a mass ratio of lithium bis(fluorosulfonyl)imide, poly(ethylene glycol)methyl ether methacrylate, poly(ethylene glycol)dimethacrylate, photoinitiator, graphite, and conductive carbon black is (35 wt % to 55 wt %):(30 wt % to 50 wt %):(1 wt % to 7.5 wt %):(1.5 wt % to 4.5 wt %):(2 wt % to 7 wt %):(1 wt % to 3 wt %). After standing, take out the solid-state electrolyte sheet and cure it under UV for 3 min to 6 min to form an interlocked structure with a cross-linked network. The cross-linked network refers to a PEG-based polymer network 204 (formed by poly(ethylene glycol)methyl ether methacrylate and poly(ethylene glycol)dimethacrylate) interpenetrated with graphite/carbon black conductive pathways 205.

According to some embodiments, another aspect of the present disclosure further provides a solid-state secondary battery including: a battery casing with an internal cavity and a bare cell within the cavity. The bare cell includes a positive electrode sheet, a solid-state electrolyte, and a negative electrode sheet stacked in sequence. The solid-state electrolyte includes: a substrate layer 200 and arrayed pillars 210 on the surface of the substrate layer 200, with gaps between the arrayed pillars 210 and having an active layer 201 on the arrayed pillars 210. The active layer 201 is on the surface of the substrate layer 200 and in the gaps. The active layer 201 is positioned between the substrate layer 200 and the positive electrode current collector and/or between the substrate layer 200 and the negative electrode current collector. The active layer between the substrate layer 200 and the positive electrode current collector constitutes part of the positive active layer, forming the positive electrode sheet together with the positive electrode current collector. The active layer between the substrate layer 200 and the negative electrode current collector constitutes part of the negative active layer, forming the negative electrode sheet together with the negative electrode current collector.

In some embodiments, the arrayed pillars 210 contain pores, and a portion of the active layer is embedded within the pores.

In some embodiments, the material of the active layer is a Ga-LLZO-coated active material.

The beneficial effects of the embodiments of the present disclosure are further illustrated below through Embodiments and comparative examples.

In Embodiment 18, the method includes: in an argon-protected glove box, mixing LiC₁₁H₁₉O₂, La(C₅H₇O₂)₃·4H₂O, and Zr(C₅H₇O₂)₄ at a molar ratio of 10.5:3:2, with oxygen and water content each below 1 ppm; using an LLZO solid-state electrolyte sheet as the substrate layer, providing a baffle having arrayed holes on the surface of the substrate layer; and evaporating the pre-mixed metal precursor using a laser for deposition. The deposition temperature is set to 700° C., a pressure in the deposition chamber is 1 kPa. Argon is used as a carrier gas at a flow rate of 3 standard liters/min. Oxygen is used as a reaction gas at a flow rate of 2 standard liters/min. The reaction time is 30 min. After the reaction, heat preservation is performed for 15 min, and then cooling is performed at 1° C./s to obtain a precursor body with array pillars grown on the surface.

LFP, carbon black, and PVDF in a ratio of 94 wt %:3 wt %:3 wt % are mixed. NMP is added to achieve 50% solid content in the slurry. Stirring operation is performed under a negative pressure for 3 h to obtain an LFP slurry. Using the solid-state electrolyte layer as the substrate layer, the LFP slurry is applied with a scraper. Ultrasonic treatment is performed for 5 min to enhance slurry infiltration between the arrayed pillars, then drying is performed. The applying-ultrasonication-drying cycle is repeated three times to form an interlocked arrayed pillar structure.

A positive electrode sheet and a negative electrode sheet are provided, where the active layer serves as part of the positive active layer of the positive electrode sheet, and the negative active layer of the negative electrode sheet is located in gaps between arrayed pillars. The negative electrode sheet, the solid-state electrolyte, and the positive electrode sheet are stacked in sequence, followed by hot pressing to obtain a bare cell, the bare cell is placed into a battery casing, and the battery casing is encapsulated to obtain the solid-state secondary battery.

Embodiment 19: Differing from Embodiment 18 in that the molar ratio of LiC₁₁H₁₉O₂, La(C₅H₇O₂₎₃·4H₂O, and Zr(C₅H₇O₂)₄ is 11:2.5:2.

Embodiment 20: Differing from Embodiment 18 in that the molar ratio of LiC₁₁H₁₉O₂, La(C₅H₇O₂)₃·4H₂O, and Zr(C₅H₇O₂)₄ is 10.5:3:2.5.

Embodiment 21: Differing from Embodiment 18 in that the positive active layer of the positive electrode sheet and the negative active layer of the negative electrode sheet are both located in gaps between arrayed pillars.

Embodiment 22: Differing from Embodiment 18 in the preparation of active layer 101: Mix LFP, nano LLZO particles, carbon black, and PVDF in a ratio of 80 wt %:14 wt %:3 wt %:3 wt %. Add NMP to achieve 60% solid content in the slurry. Perform high-speed dispersion under a negative pressure for 5 h to obtain a mixed slurry with a viscosity of 10000 mPa·s and a fineness of less than 20 μm. Pump the mixed slurry into a buffer tank, feed through a delivery pipe to a coating die, and apply onto an LLZO solid-state electrolyte sheet at a speed of 5 m/min. Transport the coated sheet via a conveyor belt into a multi-zone oven with a temperature set between 80° C. and 130° C. After drying, the self-aggregation tendency of nano LLZO particles in the slurry is presented in a structure as shown in FIG. 8.

Embodiment 23: Differing from Embodiment 22 in that the mass ratio of LFP, nano LLZO particles, carbon black, and PVDF is 76 wt %:18 wt %:3 wt %:3 wt %.

Embodiment 24: Differing from Embodiment 22 in that the mass ratio of LFP, nano LLZO particles, carbon black, and PVDF is 89 wt %:5 wt %:3 wt %:3 wt %.

Embodiment 25: Uniformly mix nano Ga-LLZO particles and LFP in a ratio of 1 wt %:9 wt % in an NMP solvent. After drying to remove NMP, calcine at 700° C. for 30 min to form a Ga-LLZO-coated LFP structure. Blend the Ga-LLZO-coated LFP structure, carbon black, and PVDF in a ratio of 94 wt %:3 wt %:3 wt %, add NMP to achieve 60% solid content in the slurry, stir under a negative pressure for 3 h to obtain an LFP slurry. Extrusion-apply the LFP slurry onto an LLZO solid-state electrolyte sheet as the substrate layer, and then dry to form a surface-coated interlocked structure as shown in FIG. 9.

Embodiment 26: Differing from Embodiment 25 in that the mass ratio of the nano Ga-LLZO particles to LFP is 2 wt %:8 wt %.

Embodiment 27: Differing from Embodiment 25 in that the mass ratio of nano Ga-LLZO particles to LFP is 0.5 wt %:9.5 wt %.

Embodiment 28: Differing from Embodiment 25 in that the mass ratio of the Ga-LLZO-coated LFP structure, carbon black, and PVDF is 98 wt %:0.6 wt %:1.4 wt %.

Embodiment 29: Differing from Embodiment 25 in that the mass ratio of the Ga-LLZO-coated LFP structure, carbon black, and PVDF is 92 wt %:4 wt %:4 wt %.

Embodiment 30: In pure water, mix graphite, carbon black, CMC, and SBR (94 wt %:2 wt %:1.5 wt %:2.5 wt %) to achieve 50% solid content in the slurry. Stir under a negative pressure for 3 h to obtain a graphite slurry. Extrusion-apply the graphite slurry onto an LLZO solid-state electrolyte sheet as the substrate layer, then dry to obtain a graphite-coated solid-state electrolyte sheet. Immerse this solid-state electrolyte sheet into the curing solution and let it stand for 30 min. In the curing solution, a mass ratio of LiFSI, PEGMA, PEGDMA, D1173, graphite, and SP is 45 wt %:40 wt %:5 wt %:3 wt %:5 wt %:2 wt %. After standing, take out the solid-state electrolyte sheet and cure it under UV for 3 min to form an interlocked structure with a cross-linked network as shown in FIG. 10.

Embodiment 31: Differing from Embodiment 30 in that the mass ratio of LIFSI, PEGMA, PEGDMA, D1173, graphite, and SP is 35 wt %:50 wt %:5 wt %:3 wt %:5 wt %:2 wt %.

Embodiment 32: Differing from Embodiment 30 in that the mass ratio of LiFSI, PEGMA, PEGDMA, D1173, graphite, and SP is 55 wt %:30 wt %:5 wt %:3 wt %:5 wt %:2 wt %.

Comparative Example 14: Differing from Embodiment 18 in that the molar ratio of LiC₁₁H₁₉O₂, La(C₅H₇O₂)₃·4H₂O, and Zr(C₅H₇O₂)₄ is 8:2.5:2.

Comparative Example 15: Differing from Embodiment 18 in that the molar ratio of LiC₁₁H₁₉O₂, La(C₅H₇O₂)₃·4H₂O, and Zr(C₅H₇O₂)₄ is 15:2.5:2.

Comparative Example 16: Differing from Embodiment 22 in that the mass ratio of LFP, nano LLZO particles, carbon black, and PVDF is 70 wt %:24 wt %:3 wt %:3 wt %.

Comparative Example 17: Differing from Embodiment 22 in that the mass ratio of LFP, nano LLZO particles, carbon black, and PVDF is 90 wt %:4 wt %:3 wt %:3 wt %.

Comparative Example 18: Differing from Embodiment 25 in that the mass ratio of nano Ga-LLZO particles to LFP is 3 wt %:7 wt %.

Comparative Example 19: Differing from Embodiment 25 in that the mass ratio of the nano Ga-LLZO particles to LFP is 0.2 wt %:9.8 wt %.

Comparative Example 20: Differing from Embodiment 25 in that the mass ratio of Ga-LLZO-coated LFP structure, carbon black, and PVDF is 90 wt %:5 wt %:5 wt %.

Comparative Example 21: Differing from Embodiment 25 in that the mass ratio of Ga-LLZO-coated LFP structure, carbon black, and PVDF is 99 wt %:0.5 wt %:0.5 wt %.

Comparative Example 22: Differing from Embodiment 30 in that the mass ratio of LiFSI: PEGMA: PEGDMA: D1173: graphite: SP is 25 wt %:60 wt %:5 wt %:3 wt %:5 wt %:2 wt %.

Comparative Example 23: Differing from Embodiment 30 in that the mass ratio of LiFSI:PEGMA:PEGDMA:D1173:graphite:SP is 65 wt %:20 wt %:5 wt %:3 wt %:5 wt %:2 wt %.

The solid-state secondary batteries prepared in the above embodiments and comparative examples were sequentially subjected to electrochemical performance testing, with results summarized in Table 2.

TABLE 2

| | Initial | Rate |
|---|---|---|
| Item | capacity/Ah | capacity/Ah |
| Embodiment | 3.00 | 2.81 |
| 18 | | |
| Embodiment | 3.06 | 2.78 |
| 19 | | |
| Embodiment | 2.99 | 2.74 |
| 20 | | |
| Embodiment | 3.06 | 2.82 |
| 21 | | |
| Embodiment | 2.72 | 2.66 |
| 22 | | |
| Embodiment | 2.61 | 2.63 |
| 23 | | |
| Embodiment | 2.80 | 2.65 |
| 24 | | |
| Embodiment | 2.87 | 2.81 |
| 25 | | |
| Embodiment | 2.80 | 2.76 |
| 26 | | |
| Embodiment | 2.87 | 2.71 |
| 27 | | |
| Embodiment | 2.74 | 2.63 |
| 28 | | |
| Embodiment | 2.62 | 2.51 |
| 29 | | |
| Embodiment | 2.95 | 2.73 |
| 30 | | |
| Embodiment | 2.95 | 2.71 |
| 31 | | |
| Embodiment | 2.98 | 2.82 |
| 32 | | |
| Comparative | 2.95 | 2.75 |
| example 14 | | |
| Comparative | 3.06 | 2.73 |
| example 15 | | |
| Comparative | 2.62 | 2.55 |
| example 16 | | |
| Comparative | 2.96 | 2.79 |
| example 17 | | |
| Comparative | 2.53 | 2.62 |
| example 18 | | |
| Comparative | 2.93 | 2.72 |
| example 19 | | |
| Comparative | 2.56 | 2.52 |
| example 20 | | |
| Comparative | 2.60 | 2.31 |
| example 21 | | |
| Comparative | 3.00 | 2.60 |
| example 22 | | |
| Comparative | 2.95 | 2.75 |
| example 23 | | |

Referring to test data in Table 2: Electrochemical tests of Embodiments 18 to 32 and Comparative Examples 14 to 23 demonstrate that the solid-state electrolyte of the present disclosure can optimize rate capacity and initial capacity.

Correspondingly, another embodiment of the present disclosure provides a method for preparing a solid-state electrolyte, differing from the above embodiments in that no arrayed pillars and branches are formed, resulting in a different structure of the obtained solid-state electrolyte. Technical features identical or corresponding to those in the above embodiments are not repeated here.

FIG. 11 is a ninth schematic structure diagram of a solid-state secondary battery according to an embodiment.

Referring to FIG. 11, the method includes: providing a substrate layer 300. Forming the coating slurry includes: uniformly mixing the active material, nano inorganic ceramic oxide particles, a conductive agent, a binder, and a dispersion solution to obtain a second mixed solution; subjecting the second mixed solution to high-speed dispersion under a negative pressure for 4 h to 6 h to obtain a slurry with a viscosity 5000 to 20000 mPa·s and a particle size of less than 20 μm. The mass ratio of the active material, nano inorganic ceramic oxide particles, conductive agent and binder is (73 wt % to 93 wt %):(5 wt % to 18 wt %):(0.6 wt % to 4.5 wt %):(1.4 wt % to 4.5 wt %).

Mix LFP, nano LLZO particles, carbon black, and PVDF in a ratio of (73 wt % to 93 wt %):(5 wt % to 18 wt %):(0.6 wt % to 4.5 wt %):(1.4 wt % to 4.5 wt %). Add NMP to achieve 60% solid content in the slurry. Perform high-speed dispersion under a negative pressure for 5 h to obtain a mixed slurry with a viscosity of 5000 mPa·s to 20000 mPa·s and a fineness of less than 20 μm. Pump the mixed slurry into a buffer tank, feed through a delivery pipe to a coating die, and apply onto an LLZO solid-state electrolyte sheet (i.e., the substrate layer 300) at 5 m/min. Transport the coated sheet via a conveyor belt into a multi-zone oven set at 80° C. to 30° C. After drying, the self-aggregation tendency of nano LLZO particles in the slurry converts them into secondary sphere aggregates 302 in the coating layer. The coating layer forms the active layer 301.

A positive electrode sheet and a negative electrode sheet are provided, where the active layer serves as part of the positive active layer of the positive electrode sheet and/or the active layer serves as part of the negative active layer of the negative electrode sheet. The negative electrode sheet, the solid-state electrolyte, and the positive electrode sheet are stacked in sequence, followed by hot pressing to obtain a bare cell, the bare cell is placed into a battery casing, and the battery casing is encapsulated to obtain the solid-state secondary battery.

FIG. 12 is a tenth schematic structure diagram of a solid-state secondary battery according to an embodiment.

Referring to FIG. 12, the method includes providing a substrate layer 300. The active material is Ga-LLZO-coated. Forming the active material layer includes: uniformly mixing Ga-LLZO particles, active particles, and a first dispersion solution to form a first mixed solution; drying the first mixed solution to form a first precursor; calcining the first precursor to form a Ga-LLZO-coated active material. The mass ratio of Ga-LLZO particles to active particles is (0.5 wt % to 2 wt %):(8 wt % to 9.5 wt %). If the active material is the positive electrode active material, the active material may be a lithium source material; and if the active material is the negative electrode active material, the active material may be graphite.

Uniformly mix nano Ga-LLZO particles and LFP in a ratio of (0.5 wt % to 2 wt %):(8 wt % to 9.5 wt %) in an NMP solvent. After drying to remove NMP, calcine at 700° C. for 30 to 60 min to form a Ga-LLZO-coated LFP structure. Blend the Ga-LLZO-coated LFP structure, carbon black, and PVDF in a ratio of (92 wt % to 98 wt %):(0.6 wt % to 4 wt %):(1.4 wt % to 4 wt %), add NMP to achieve 60% solid content in the slurry, and stir under a negative pressure for 3 h to 5 h to obtain an LFP slurry. Extrusion-apply the LFP slurry onto an LLZO solid-state electrolyte sheet as the substrate layer, and then dry to form a surface-coated interlocked structure. The surface-coated interlocked structure is the Ga-LLZO-coated active material 303.

A positive electrode sheet and a negative electrode sheet are provided, where the active layer serves as part of the positive active layer of the positive electrode sheet and/or the active layer serves as part of the negative active layer of the negative electrode sheet. The negative electrode sheet, the solid-state electrolyte, and the positive electrode sheet are stacked in sequence, followed by hot pressing to obtain a bare cell, the bare cell is placed into a battery casing, and the battery casing is encapsulated to obtain the solid-state secondary battery.

FIG. 13 is an eleventh schematic structure diagram of a solid-state secondary battery according to an embodiment.

Referring to FIG. 13, the method includes: providing a substrate layer 100. The active material is graphite. After forming the solid-state electrolyte, the method further includes: uniformly mixing lithium bis(fluorosulfonyl)imide, poly(ethylene glycol)methyl ether methacrylate, poly(ethylene glycol)dimethacrylate, a photoinitiator, graphite, and conductive carbon black to obtain a curing solution; immersing the solid-state electrolyte into the curing solution and performing curing treatment. The mass ratio of lithium bis(fluorosulfonyl)imide, poly(ethylene glycol)methyl ether methacrylate, poly(ethylene glycol)dimethacrylate, photoinitiator, graphite and conductive carbon black is (35 wt % to 55 wt %):(30 wt % to 50 wt %):(1 wt % to 7.5 wt %): (1.5 wt % to 4.5 wt %): (2 wt % to 7 wt %):(1 wt % to 3 wt %).

In pure water, mix graphite, carbon black, CMC, and SBR in a ratio of (92 wt % to 96 wt %):(1 wt % to 3 wt %):(0.5 wt % to 2.5 wt %):(1.5 wt % to 3.5 wt %) to achieve 50% solid content in the slurry. Stir under a negative pressure for 3 h to obtain a graphite slurry. Extrusion-apply the graphite slurry onto an LLZO solid-state electrolyte sheet as the substrate layer 300, then dry to form a graphite-coated solid-state electrolyte sheet. Immerse this solid-state electrolyte sheet into a curing solution for 30 min to 60 min. In the curing solution, a mass ratio of lithium bis(fluorosulfonyl)imide, poly(ethylene glycol)methyl ether acrylate, polyethylene glycol dimethacrylate, photoinitiator, graphite and conductive carbon black is (35 wt % to 55 wt %):(30 wt % to 50 wt %):(1 wt % to 7.5 wt %):(1.5 wt % to 4.5 wt %):(2 wt % to 7 wt %):(1 wt % to 3 wt %). After standing, take out the solid-state electrolyte sheet and cure it under UV for 3 min to 6 min to form an interlocked structure with a cross-linked network. The cross-linked network refers to a PEG-based polymer network 304 (formed by poly(ethylene glycol)methyl ether methacrylate and poly(ethylene glycol)dimethacrylate) interpenetrated with graphite/carbon black conductive pathways 305.

A positive electrode sheet and a negative electrode sheet are provided, where the active layer serves as the positive active layer of the positive electrode sheet. The negative electrode sheet, the solid-state electrolyte, and the positive electrode sheet are stacked in sequence, followed by hot pressing to obtain a bare cell, the bare cell is placed into a battery casing, and the battery casing is encapsulated to obtain the solid-state secondary battery.

Embodiment 33: Preparing the active layer 101 includes operations below. Mix LFP, nano LLZO particles, carbon black, and PVDF in a ratio of 80 wt %:14 wt %:3 wt%:3 wt %. Add NMP to achieve 60% solid content of the slurry. Perform high-speed dispersion under a negative pressure for 5 h to obtain a mixed slurry with a viscosity of 10000 mPa·s and a fineness of less than 20 μm. Applying: Pump the mixed slurry into a buffer tank, feed through a delivery pipe to a coating die, and apply onto an LLZO solid-state electrolyte sheet at 5 m/min. Transport the coated sheet via a conveyor belt into a multi-zone oven set at 80° C. to 130° C. After drying, the self-aggregation tendency of nano LLZO particles in the slurry forms the structure shown in FIG. 10.

A positive electrode sheet and a negative electrode sheet are provided, where the active layer serves as part of the positive active layer of the positive electrode sheet and/or the active layer serves as part of the negative active layer of the negative electrode sheet. The negative electrode sheet, the solid-state electrolyte, and the positive electrode sheet are stacked in sequence, followed by hot pressing to obtain a bare cell, the bare cell is placed into a battery casing, and the battery casing is encapsulated to obtain the solid-state secondary battery.

Embodiment 34: Differing from Embodiment 33 in that the mass ratio of LFP, nano LLZO particles, carbon black, and PVDF is 76 wt %:18 wt %:3 wt %:3 wt %.

Embodiment 35: Differing from Embodiment 33 in that the mass ratio is 89 wt %:5 wt %:3 wt %:3 wt %.

Embodiment 36: Mix nano Ga-LLZO particles and LFP in a ratio of 1 wt %:9 wt %) in an NMP solvent. After drying to remove NMP, calcine at 700° C. for 30 min to form a Ga-LLZO-coated LFP structure. Blend the Ga-LLZO-coated LFP structure, carbon black, and PVDF in a ratio of 94 wt %:3 wt %:3 wt %, add NMP to achieve 60% solid content in the slurry, and stir under a negative pressure for 3 h to obtain an LFP slurry. Extrusion-apply the LFP slurry onto an LLZO solid-state electrolyte sheet as the substrate layer, and then dry to form a surface-coated interlocked structure as shown in FIG. 11.

A positive electrode sheet and a negative electrode sheet are provided, where the active layer serves as the positive active layer of the positive electrode sheet. The negative electrode sheet, the solid-state electrolyte, and the positive electrode sheet are stacked in sequence, followed by hot pressing to obtain a bare cell, the bare cell is placed into a battery casing, and the battery casing is encapsulated to obtain the solid-state secondary battery.

Embodiment 37: Differing from Embodiment 36 in that the mass ratio of nano Ga-LLZO particles to LFP is 2 wt %:8 wt %.

Embodiment 38: Differing from Embodiment 36 in that the mass ratio of nano Ga-LLZO particles is 0.5 wt %:9.5 wt %.

Embodiment 39: Differing from Embodiment 36 in that the mass ratio of the Ga-LLZO-coated LFP structure, carbon black, and PVDF is 98 wt %:0.6 wt %:1.4 wt %.

Embodiment 40: Differing from Embodiment 36 in that the mass ratio of the Ga-LLZO-coated LFP structure, carbon black, and PVDF is 92 wt %:4 wt %:4 wt %.

### Embodiment 41

In pure water, mix graphite, carbon black, CMC, and SBR (94 wt %:2 wt %:1.5 wt %:2.5 wt %) to achieve 50% solid content in the slurry. Stir under a negative pressure for 3 h to obtain a graphite slurry. Extrusion-apply the graphite slurry onto an LLZO solid-state electrolyte sheet as the substrate layer, then dry to obtain a graphite-coated solid-state electrolyte sheet. Immerse this solid-state electrolyte sheet into the curing solution and let it stand for 30 min. In the curing solution, a mass ratio of LiFSI, PEGMA, PEGDMA, D1173, graphite, and SP is 45 wt %:40 wt %:5 wt %:3 wt %:5 wt %:2 wt %. After standing, take out the solid-state electrolyte sheet and cure it under UV for 3 min to form an interlocked structure with a cross-linked network as shown in FIG. 9.

A positive electrode sheet and a negative electrode sheet are provided, where the active layer serves as the positive active layer of the positive electrode sheet. The negative electrode sheet, the solid-state electrolyte, and the positive electrode sheet are stacked in sequence, followed by hot pressing to obtain a bare cell, the bare cell is placed into a battery casing, and the battery casing is encapsulated to obtain the solid-state secondary battery.

Embodiment 42: Differing from Embodiment 41 in that the mass ratio of LIFSI, PEGMA, PEGDMA, D1173, graphite, and SP is 35 wt %:50 wt %:5 wt %:3 wt %:5 wt %:2 wt %.

Embodiment 43: Differing from Embodiment 41 in that the mass ratio of LiFSI, PEGMA, PEGDMA, D1173, graphite, and SP is 55 wt %:30 wt %:5 wt %:3 wt %:5 wt %:2 wt %.

Comparative Example 24: Differing from Embodiment 33 in that the mass ratio of LFP, nano LLZO particles, carbon black, and PVDF is 70 wt %:24 wt %:3 wt %:3 wt %.

Comparative Example 25: Differing from Embodiment 33 in that the mass ratio of LFP, nano LLZO particles, carbon black, and PVDF is 90 wt %:4 wt %:3 wt %:3 wt %.

Comparative Example 26: Differing from Embodiment 36 in that the mass ratio of nano Ga-LLZO particles to LFP is 3 wt %:7 wt %.

Comparative Example 27: Differing from Embodiment 36 in that the mass ratio of nano Ga-LLZO particles to LFP is 0.2 wt %:9.8 wt %.

Comparative Example 28: Differing from Embodiment 36 in that the mass ratio of Ga-LLZO-coated LFP structure, carbon black, and PVDF is 90 wt %:5 wt %:5 wt %.

Comparative Example 29: Differing from Embodiment 36 in that the mass ratio of Ga-LLZO-coated LFP structure, carbon black, and PVDF is 99 wt %:0.5 wt %:0.5 wt %.

Comparative Example 30: Differing from Embodiment 41 in that the mass ratio of LiFSI: PEGMA: PEGDMA: D1173: graphite: SP is 25 wt %:60 wt %:5 wt %:3 wt %:5 wt %:2 wt %.

Comparative Example 31: Differing from Embodiment 41 in that the mass ratio of LiFSI:PEGMA:PEGDMA:D1173:graphite:SP is 65 wt %:20 wt %:5 wt %:3 wt %:5 wt %:2 wt %.

The solid-state secondary batteries prepared in the above embodiments and comparative examples were sequentially subjected to electrochemical performance testing, with results summarized in Table 3.

TABLE 3

| | Initial | Rate |
|---|---|---|
| Item | capacity/Ah | capacity/Ah |
| Embodiment | 2.57 | 2.48 |
| 33 | | |
| Embodiment | 2.44 | 2.36 |
| 34 | | |
| Embodiment | 2.83 | 2.67 |
| 35 | | |
| Embodiment | 2.69 | 2.62 |
| 36 | | |
| Embodiment | 2.42 | 2.38 |
| 37 | | |
| Embodiment | 2.88 | 2.73 |
| 38 | | |
| Embodiment | 2.76 | 2.65 |
| 39 | | |
| Embodiment | 2.65 | 2.56 |
| 40 | | |
| Embodiment | 2.98 | 2.79 |
| 41 | | |
| Embodiment | 2.97 | 2.75 |
| 42 | | |
| Embodiment | 3.00 | 2.84 |
| 43 | | |
| Comparative | 2.04 | 1.98 |
| example 24 | | |
| Comparative | 3.00 | 2.82 |
| example 25 | | |
| Comparative | 2.11 | 2.08 |
| example 26 | | |
| Comparative | 2.95 | 2.76 |
| example 27 | | |
| Comparative | 2.59 | 2.54 |
| example 28 | | |
| Comparative | 2.61 | 2.33 |
| example 29 | | |
| Comparative | 3.03 | 2.61 |
| example 30 | | |
| Comparative | 3.00 | 2.78 |
| example 31 | | |

Referring to test data in Table 3: Electrochemical tests of Embodiments 33 to 43 and Comparative Examples 24 to 31 demonstrate that the solid-state electrolyte provided by the embodiments of the present disclosure can optimize rate capacity and initial capacity.

According to some embodiments, the present disclosure further provides an energy storage system including: the secondary battery prepared by the method according to any one of the above embodiments, or the solid-state secondary battery according to the above embodiments.

According to some embodiments, the present disclosure further provides an electric equipment including: the solid-state secondary battery prepared by the method according to any one of the above embodiments, the solid-state secondary battery according to the above embodiments, or the energy storage system according to the above embodiments.

Those skilled in the art should appreciate that that the preceding implementations are specific embodiments for implementing the present disclosure, and in practice, various changes may be made in the form and details without departing from the spirit and scope of the embodiments of the present disclosure. Any person skilled in the art may make variations and modifications without departing from the spirit and scope of the embodiments of the present disclosure. Therefore, the protection scope of the embodiments of the present disclosure shall be defined by the appended claims.

What is claimed is:

1. A method for preparing a solid-state secondary battery, comprising:
forming a solid-state electrolyte, including:
preparing a ceramic aerosol, wherein the ceramic aerosol includes inorganic ceramic oxide particles and polyimide particles;
providing a substrate layer and spraying the ceramic aerosol onto at least one side of the substrate layer;
performing heat treatment on the substrate layer to remove the polyimide particles and convert the inorganic ceramic oxide particles into a plurality of branches on the at least one side of the substrate layer, wherein gaps are formed between adjacent branches of the plurality of branches;
preparing a coating slurry;
applying the coating slurry onto a side of the substrate layer, the coating slurry flowing into the gaps; and
performing drying treatment to convert the coating slurry into an active layer to obtain the solid-state electrolyte including the substrate layer and the plurality of branches;
preparing a positive electrode sheet and a negative electrode sheet, including:
providing a current collector, wherein the active layer is located between the current collector and the substrate layer; and
stacking the negative electrode sheet, the solid-state electrolyte, and the positive electrode sheet in sequence, followed by hot pressing to obtain a bare cell, placing the bare cell into a battery casing, and encapsulating the battery casing to obtain the solid-state secondary battery.

2. The method according to claim 1, wherein the plurality of branches contain pores, and the coating slurry further flows into the pores.

3. The method according to claim 2, wherein before performing the drying treatment, the method further comprises:
performing ultrasonic treatment to allow the coating slurry to fill the pores, wherein the ultrasonic treatment has an ultrasonic treatment time of 3 min to 15 min, and an ultrasonic frequency of 20 kHz to 5 MHz.

4. The method according to claim 2, wherein the coating slurry includes a dispersion solution containing a wetting agent configured to facilitate the flow of the coating slurry into the pores.

5. The method according to claim 1, wherein in the operation of preparing the ceramic aerosol, a volume ratio of the inorganic ceramic oxide particles to the polyimide particles is 1:(1 to 10).

6. The method according to claim 1, wherein process parameters for the heat treatment include:
a reaction temperature of 500° C. to 1000° C.;
a calcination time of 0.8 h to 1.2 h; and
a sweeping gas flow rate of 0.5 L/min to 3 L/min.

7. The method according to claim 1, wherein the inorganic ceramic oxide particles include Li_{0.33}La_{0.56}TiO₃ (LLTO), Li₇La₃Zr₂O₁₂ (LLZTO), or C₂F₆LiNO₄S₂ (LiTFSI).

8. The method according to claim 1, wherein preparing the ceramic aerosol includes:
feeding, by a gas delivery device, a mixture of the inorganic ceramic oxide particles and the polyimide particles into an aerosol chamber with a carrier gas to enable uniform dispersion of the mixture so as to form the ceramic aerosol, wherein the carrier gas is helium or oxygen.

9. The method according to claim 1, wherein the coating slurry includes an active material coated with Ga-LLZO, and forming the active material includes:
uniformly mixing Ga-LLZO particles, active particles, and a solution to form a first mixed solution;
drying the first mixed solution to form a first precursor; and
calcining the first precursor to form the active material;
wherein a mass ratio of the Ga-LLZO particles to the active particles is (0.5 wt % to 2 wt %):(8 wt % to 9.5 wt %).

10. The method according to claim 9, wherein preparing the coating slurry includes:
uniformly mixing the active material, nano inorganic ceramic oxide particles, a conductive agent, a binder, and a dispersion solution to obtain a second mixed solution; and
subjecting the second mixed solution to high-speed dispersion under a negative pressure for 4 h to 6 h to obtain the coating slurry, wherein the coating slurry has a viscosity of 5000 mPa·s to 20000 mPa·s;
wherein a mass ratio of the active material, the nano inorganic ceramic oxide particles, the conductive agent, and the binder is (73 wt % to 93 wt %):(5 wt % to 18 wt %):(0.6 wt % to 4.5 wt %):(1.4 wt % to 4.5 wt %).

11. The method according to claim 10, wherein the second mixed solution has an average particle size of less than 20 μm.

12. The method according to claim 1, wherein preparing the coating slurry includes:
uniformly mixing an active material, nano inorganic ceramic oxide particles, a conductive agent, a binder, and a dispersion solution to obtain a mixed solution; and
subjecting the mixed solution to high-speed dispersion under a negative pressure for 4 h to 6 h to obtain the coating slurry, wherein the coating slurry has a viscosity of 5000 mPa·s to 20000 mPa·s;
wherein a mass ratio of the active material, the nano inorganic ceramic oxide particles, the conductive agent, and the binder is (73 wt % to 93 wt %):(5 wt % to 18 wt %):(0.6 wt % to 4.5 wt %):(1.4 wt % to 4.5 wt %).

13. The method according to claim 12, wherein the mixed solution has an average particle size of less than 20 μm.

14. The method according to claim 9, wherein in response to the active material being a positive electrode active material, the current collector is a positive electrode current collector; and
wherein in response to the active material being a negative electrode active material, the current collector is a negative electrode current collector.

15. The method according to claim 14, wherein the positive electrode active material is a lithium source material, and the negative electrode active material is graphite.

16. The method according to claim 1, wherein the coating slurry includes an active material which is graphite, and after forming the solid-state electrolyte, the method further comprises:
uniformly mixing lithium bis(fluorosulfonyl)imide, poly(ethylene glycol)methyl ether methacrylate, poly(ethylene glycol)dimethacrylate, a photoinitiator, graphite, and conductive carbon black to obtain a curing solution; and
immersing the solid-state electrolyte into the curing solution and performing curing treatment on the solid-state electrolyte with the curing solution;
wherein a mass ratio of lithium bis(fluorosulfonyl)imide, poly(ethylene glycol)methyl ether methacrylate, poly(ethylene glycol)dimethacrylate, the photoinitiator, the graphite and the conductive carbon black is (35 wt % to 55 wt %):(30 wt % to 50 wt %):(1 wt % to 7.5 wt %):(1.5 wt % to 4.5 wt %):(2 wt % to 7 wt %):(1 wt % to 3 wt %).

17. The method according to claim 1, wherein the current collector is a positive electrode current collector, and preparing the positive electrode sheet includes:
providing the positive electrode current collector over a surface of the active layer; and
performing hot pressing treatment on the solid-state electrolyte and the positive electrode current collector, wherein the active layer and the positive electrode current collector constitute the positive electrode sheet.

18. The method according to claim 17, wherein the positive electrode sheet further includes a positive sub-active layer, and before providing the positive electrode current collector over the surface of the active layer, preparing the positive electrode sheet further includes:
preparing the positive sub-active layer over the surface of the active layer, wherein the positive sub-active layer is between the active layer and the positive electrode current collector;
wherein the active layer, the positive sub-active layer, and the positive electrode current collector constitute the positive electrode sheet.

19. The method according to claim 1, wherein the current collector is a negative electrode current collector, and preparing the negative electrode sheet includes:
providing the negative electrode current collector over a surface of the active layer; and
performing hot pressing treatment on the solid-state electrolyte and the negative electrode current collector, wherein the active layer and the negative electrode current collector constitute the positive electrode sheet.

20. The method according to claim 19, wherein the negative electrode sheet further includes a negative sub-active layer, and before providing the negative electrode current collector over the surface of the active layer, preparing the negative electrode sheet further includes:
preparing the negative sub-active layer over the surface of the active layer, wherein the negative sub-active layer is between the active layer and the negative electrode current collector;
wherein the active layer, the negative sub-active layer, and the negative electrode current collector constitute the negative electrode sheet.
